(19) United States
(12) Patent Application Publication
(10) Pub. No.: US 2026/0179581 A1
(43) Pub. Date: Jun. 25, 2026

(54) DRIVING CIRCUIT, DRIVING METHOD, DISPLAY PANEL, AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Ziyang YU, Beijing (CN); Haijun QIU, Beijing (CN); Ming HU, Beijing (CN); Zhiliang JIANG, Beijing (CN); Qingqing YAN, Beijing (CN); Quanyong GU, Beijing (CN)

(21) Appl. No.: 18/996,645

(22) PCT Filed: May 17, 2024
(86) PCT No.: PCT/CN2024/093787

§ 371 Date: Jan. 17, 2025

(30) Foreign Application Priority Data
Jun. 21, 2023 (CN) 202310747802.8

(51) Int. Cl. G09G 3/36; G09G 3/3266

(52) U.S. Cl. CPC G09G 3/3688; G09G 3/3266; G09G 3/3648

(57) ABSTRACT

A driving circuit, a driving method, a display panel, and a display device are provided. The driving circuit includes: a strobe circuit, wherein the strobe circuit is electrically connected to the strobe control line, a data output terminal of a source driver, and a scanning line, and is configured to control, under control of a strobe control signal provided by the strobe control line, the data output terminal to be connected to or disconnected from the scanning line.

### CROSS-REFERENCE TO RELATED APPLICATION

This application is a U.S. national application of PCT application No. PCT/CN2024/093787 filed on May 17, 2024, which claims priority to Chinese Patent Application No. 202310747802.8, filed on Jun. 21, 2023, the disclosure of which is hereby incorporated by reference in its entirety.

### TECHNICAL FIELD

The present disclosure relates to the field of display technologies, and in particular, to a driving circuit, a driving method, a display panel and a display device.

### BACKGROUND

OLED (Organic Light Emitting Diode) display technology has the advantages of high contrast, fast response, low power consumption and the like. In order to further reduce power consumption, LTPO (Low Temperature Polycrystalline Oxide) display technology implemented by combining LTPS (Low Temperature Polysilicon)+IGZO (Indium Gallium Zinc Oxide) can realize low frame frequency display, and reduce driving power consumption by reducing repeated refreshing of static pictures. However, when an existing OLED display updates a picture, it is still necessary to initialize and write all pixel voltages in one frame. In some special pictures, most of the pixel voltages of the whole screen need not be updated, that is, the original display brightness can be maintained through low-leakage LTPO TFT (Thin Film Transistor), and waste of data line power consumption is caused by repeated flashing of these pixels.

### SUMMARY

In a first aspect, a driving circuit is provided. The driving circuit includes: a strobe circuit, wherein the strobe circuit is electrically connected to the strobe control line, a data output terminal of a source driver, and a scanning line, and is configured to control, under control of a strobe control signal provided by the strobe control line, the data output terminal to be connected to or disconnected from the scan line.

Optionally, the data output terminal is electrically connected to a data line.

Optionally, the strobe circuit is further electrically connected to a data line, and is configured to control the data output terminal to be connected to or disconnected from the data line under control of the strobe control signal.

Optionally, the strobe circuit includes a first strobe sub-circuit and a second strobe sub-circuit; the first strobe sub-circuit is electrically connected to the strobe control line, the data output terminal, and the scan line, and is configured to control the data output terminal to be connected to or disconnected from the scan line under control of a strobe control signal provided by the strobe control line; the second strobe sub-circuit is electrically connected to the strobe control line, the data output terminal, and the data line, and is configured to control the data output terminal to be connected to or disconnected from the data line under control of the strobe control signal.

Optionally, the strobe control line includes a first strobe control line and a second strobe control line; the strobe circuit includes a first strobe sub-circuit and a second strobe sub-circuit; the first strobe sub-circuit is electrically connected to the first strobe control line, the second strobe control line, the data output terminal, and the scan line, and is configured to control, under control of a first strobe control signal provided by the first strobe control line and a second strobe control signal provided by the second strobe control line, the data output terminal to be connected to or disconnected from the scan line; the second strobe sub-circuit is electrically connected to the first strobe control line, the second strobe control line, the data output terminal, and the data line, and is configured to control the data output terminal to be connected to or disconnected from the data line under control of the first strobe control signal and the second strobe control signal.

Optionally, the strobe circuit includes a first transistor, and the strobe control line includes a first strobe control line; a gate electrode of the first transistor is electrically connected to the first strobe control line, a first electrode of the first transistor is electrically connected to the data output terminal, a second electrode of the first transistor is electrically connected to the scan line, and the first transistor is a P-type transistor; or the strobe circuit includes a first transistor, and the strobe control line includes a second strobe control line; a gate electrode of the first transistor is electrically connected to the second strobe control line, a first electrode of the first transistor is electrically connected to the data output terminal, a second electrode of the first transistor is electrically connected to the scan line, and the first transistor is an N-type transistor.

Optionally, the strobe circuit includes a first transistor and a second transistor, and the strobe control line includes a first strobe control line; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the first strobe control line, a first electrode of the second transistor is electrically connected to the data output terminal, and a second electrode of the second transistor is electrically connected to the data line; the first transistor is a P-type transistor, and the second transistor is an N-type transistor.

Optionally, the strobe circuit includes a first transistor and a second transistor, and the strobe control line includes a second strobe control line; a gate electrode of the first transistor is electrically connected to the second strobe control line, a first electrode of the first transistor is electrically connected to the data output terminal, and a second electrode of the first transistor is electrically connected to the scan line; a gate electrode of the second transistor is electrically connected to the second strobe control line, a first electrode of the second transistor is electrically connected to the data output terminal, and a second electrode of the second transistor is electrically connected to the data line; the first transistor is an N-type transistor, and the second transistor is a P-type transistor.

Optionally, the strobe control line includes a first strobe control line and a second strobe control line, the first strobe sub-circuit includes a first transistor, and the second strobe sub-circuit includes a second transistor; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a first electrode of the second transistor is electrically connected to the data output terminal, and a second electrode of the second transistor is electrically connected to the data line; both the first transistor and the second transistor are P-type transistors.

Optionally, the strobe control line includes a first strobe control line and a second strobe control line, the first strobe sub-circuit includes a first transistor, and the second strobe sub-circuit includes a second transistor; a gate electrode of the first transistor is electrically connected to the second strobe control line, a first electrode of the first transistor is electrically connected to the data output terminal, and a second electrode of the first transistor is electrically connected to the scan line; a gate electrode of the second transistor is electrically connected to the first strobe control line, a first electrode of the second transistor is electrically connected to the data output terminal, and a second electrode of the second transistor is electrically connected to the data line; both the first transistor and the second transistor are N-type transistors.

Optionally, the strobe circuit includes a first transistor and a second transistor, and the strobe control line includes a first strobe control line and a second strobe control line; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a second electrode of the second transistor is electrically connected to the data output terminal, and a second electrode of the first transistor is electrically connected to the scan line; the first transistor is a P-type transistor, and the second transistor is an N-type transistor.

Optionally, the strobe control line includes a first strobe control line and a second strobe control line; the first strobe control sub-circuit includes a first transistor and a second transistor, and the second strobe control sub-circuit includes a third transistor and a fourth transistor; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a first electrode of the second transistor is electrically connected to the data output terminal, and a second electrode of the second transistor is electrically connected to the scan line; a gate electrode of the third transistor is electrically connected to the first strobe control line, a first electrode of the third transistor is electrically connected to the data output terminal, and a second electrode of the third transistor is electrically connected to the data line; a gate electrode of the fourth transistor is electrically connected to the second strobe control line, a first electrode of the fourth transistor is electrically connected to the data output terminal, and a second electrode of the fourth transistor is electrically connected to the data line; the first transistor and the fourth transistor are P-type transistors, and the second transistor and the third transistor are N-type transistors.

In a second aspect, a driving method is provided. The driving method is applied to the driving circuit according to the above, the driving method includes: controlling, by the strobe circuit, connection between the data output terminal and the scan line, in at least part of time in a blank time period between two frames of display time, under control of the strobe control signal provided by the strobe control line.

Optionally, the data output terminal is electrically connected to a data line, and the driving method further includes: in a data writing time period in a frame of display time, providing, by the data output terminal, a data voltage to a data line electrically connected to the data output terminal.

Optionally, the strobe circuit is further electrically connected to a data line, and the driving method further includes: in a data writing time period in a frame of display time, under control of the strobe control signal, controlling, by the strobe circuit, the data output terminal to be connected with the data line, so that the data output terminal provides a data voltage to the data line.

In a third aspect, a display panel is provided. The display panel includes: a source driver, a plurality of columns of scan lines, and the driving circuit according to the above; wherein the source driver includes a plurality of data output terminals; the strobe circuit included in the driving circuit is electrically connected to the strobe control line, the data output terminal, and the scan line, and is configured to control the data output terminal to be connected to or disconnected from the scan line under control of a strobe control signal provided by the strobe control line.

Optionally, the display panel in at least one embodiment further includes: a plurality of columns of pixel circuits; wherein a column of the plurality columns of scan lines is electrically connected to a column of the plurality of columns of pixel circuits, respectively.

Optionally, the display panel includes a plurality of columns of data lines, and the data output terminal is directly electrically connected to the data lines; or the strobe circuit is further electrically connected to the data lines, and is configured to control, under control of the strobe control signal, the data output terminal to be connected to or disconnected from the data lines.

Optionally, the source driver is on a first side edge of the display panel, and the driving circuit is on the first side edge of the display panel; or the source driver is on a first side edge of the display panel, the driving circuit is on a second side edge of the display panel, and the first side edge and the second side edge are opposite side edges.

Optionally, the pixel circuit includes a light-emitting element, a light-emitting driving circuit and a control circuit; the light-emitting driving circuit is electrically connected to a first node, a second node, and a third node, and is configured to generate a driving current flowing through the second node and the third node under control of a potential of the first node; the light-emitting element is electrically connected to the third node; the control circuit is electrically connected to a first gate line, a scan line, the first node, and the third node, and is configured to control the first node to be connected to or disconnected from the third node under control of a first gate driving signal provided by the first gate line and a scanning signal provided by the scan line.

Optionally, the control circuit includes a first control circuit and a second control circuit; the first control circuit is electrically connected to the first gate line, the first node, and an intermediate node, and the first control circuit is configured to control the first node to be connected to or disconnected from the intermediate node under control of a first gate driving signal provided by the first gate line; the second control circuit is electrically connected to a scan line, the intermediate node, and the third node, and is configured to control the intermediate node to be connected to or disconnected from the third node under control of a scan signal provided by the scan line.

Optionally, the control circuit includes a first control circuit and a second control circuit; the first control circuit is electrically connected to the first gate line, the third node, and an intermediate node, and is configured to control the third node to be connected to or disconnected from the intermediate node under control of a first gate driving signal provided by the first gate line; the second control circuit is electrically connected to the scan line, the intermediate node, and the first node, and is configured to control the intermediate node to be connected to or disconnected from the first node under control of a scan signal provided by the scan line.

Optionally, the pixel circuit further includes a first initialization circuit; the first initialization circuit is electrically connected to a first initial control terminal, a first initial voltage terminal, and the second node, and is configured to write a first initial voltage, provided by the first initial voltage terminal, into the second node under control of a first initial control signal provided by the first initial control terminal.

Optionally, the pixel circuit further includes a second initialization circuit; the second initialization circuit is electrically connected to a second initial control terminal, a second initial voltage terminal, and the third node, and is configured to write a second initial voltage, provided by the second initial voltage terminal, into the third node under control of a second initial control signal provided by the second initial control terminal.

Optionally, the pixel circuit further includes a data writing circuit, a first light-emitting control circuit, a second light-emitting control circuit, and an energy storage circuit; the data writing circuit is electrically connected to a second gate line, a data line, and the second node, and is configured to write a data voltage, provided by the data line, into the second node under control of a second gate driving signal provided by the second gate line; the first light-emitting control circuit is electrically connected to a light-emitting control line, a power supply voltage terminal, and the second node, and is configured to control, under control of a light-emitting control signal provided by the light-emitting control line, the power supply voltage terminal to be connected to or disconnected from the second node; the second light-emitting control circuit is electrically connected to the light-emitting control line, the third node, and a first electrode of the light-emitting element, and is configured to control, under control of the light-emitting control signal, the third node to be electrically connected to a first electrode of the light-emitting element, and a second electrode of the light-emitting element is electrically connected to a third voltage terminal; the energy storage circuit is electrically connected to the first node and configured to store electric energy.

Optionally, the pixel circuit further includes a third initialization circuit; the third initialization circuit is electrically connected to a first initial control terminal, a third initial voltage terminal, and the first electrode of the light-emitting element, and is configured to write a third initial voltage, provided by the third initial voltage terminal, into the first electrode of the light-emitting element under control of a first initial control signal provided by the first initial control terminal.

Optionally, the first control circuit includes a first control transistor, and the second control circuit includes a second control transistor; a gate electrode of the first control transistor is electrically connected to the first gate line, a first electrode of the first control transistor is electrically connected to the first node, and a second electrode of the first control transistor is electrically connected to the intermediate node; a gate electrode of the second control transistor is electrically connected to the scan line, a first electrode of the second control transistor is electrically connected to the intermediate node, and a second electrode of the second control transistor is electrically connected to the third node.

Optionally, the first control circuit includes a first control transistor, and the second control circuit includes a second control transistor; a gate electrode of the first control transistor is electrically connected to the first gate line, a first electrode of the first control transistor is electrically connected to the intermediate node, and a second electrode of the first control transistor is electrically connected to the third node; a gate electrode of the second control transistor is electrically connected to the scan line, a first electrode of the second control transistor is electrically connected to the first node, and a second electrode of the second control transistor is electrically connected to the intermediate node.

Optionally, the first initialization circuit includes a first initialization transistor; a gate electrode of the first initialization transistor is electrically connected to the first initial control terminal, a first electrode of the first initialization transistor is electrically connected to the first initial voltage terminal, and a second electrode of the first initialization transistor is electrically connected to the second node.

Optionally, the second initialization circuit includes a second initialization transistor; a gate electrode of the second initialization transistor is electrically connected to the second initial control terminal, a first electrode of the second initialization transistor is electrically connected to the second initial voltage terminal, and a second electrode of the second initialization transistor is electrically connected to the third node.

Optionally, the data writing circuit includes a writing transistor, the first light-emitting control circuit includes a first light-emitting control transistor, and the second light-emitting control circuit includes a second light-emitting control transistor; the light-emitting driving circuit includes a driving transistor, and the energy storage circuit includes a storage capacitor; a gate electrode of the write transistor is electrically connected to the second gate line, a first electrode of the write transistor is electrically connected to the data line, and a second electrode of the write transistor is electrically connected to the second node; a gate electrode of the first light-emitting control transistor is electrically connected to the light-emitting control line, a first electrode of the first light-emitting control transistor is electrically connected to the power supply voltage terminal, and a second electrode of the first light-emitting control transistor is electrically connected to the second node; a gate electrode of the second light-emitting control transistor is electrically connected to the light-emitting control line, a first electrode of the second light-emitting control transistor is electrically connected to the third node, and a second electrode of the second light-emitting control transistor is electrically connected to a first electrode of the light-emitting element; a gate electrode of the driving transistor is electrically connected to the first node, a first electrode of the driving transistor is electrically connected to the second node, and a second electrode of the driving transistor is electrically connected to the third node; a first end of the storage capacitor is electrically connected to the first node, and a second end of the storage capacitor is electrically connected to the power supply voltage terminal.

Optionally, the third initialization circuit includes a third initialization transistor; a gate electrode of the third initialization transistor is electrically connected to the first initial control terminal, a first electrode of the third initialization transistor is electrically connected to the third initial voltage terminal, and a second electrode of the third initialization transistor is electrically connected to a first electrode of the light-emitting element.

In a fourth aspect, a display device is provided. The display device includes the display panel according to the above.

### BRIEF DESCRIPTION OF THE DRAWINGS

FIG. 1 is a structural diagram of a driving circuit according to an embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a structural diagram of a driving circuit according to at least one embodiment of the present disclosure;

FIG. 6 is a structural diagram of a driving circuit according to at least one embodiment of the present disclosure;

FIG. 7 is a structural diagram of a driving circuit according to at least one embodiment of the present disclosure;

FIG. 8 is a structural diagram of a driving circuit according to at least one embodiment of the present disclosure;

FIG. 9 is a structural diagram of a driving circuit according to at least one embodiment of the present disclosure;

FIG. 10 is a structural diagram of a driving circuit according to at least one embodiment of the present disclosure;

FIG. 11 is a structural diagram of a driving circuit according to at least one embodiment of the present disclosure;

FIG. 12 is a structural diagram of a driving circuit according to at least one embodiment of the present disclosure;

FIG. 13 is a working timing diagram of at least one embodiment of the driving circuit shown in FIG. 12;

FIG. 14 is a structural diagram of a driving circuit according to at least one embodiment of the present disclosure;

FIG. 15 is a structural diagram of a driving circuit according to at least one embodiment of the present disclosure;

FIG. 16 is a structural diagram of a driving circuit according to at least one embodiment of the present disclosure;

FIG. 17 is a structural diagram of a display panel according to at least one embodiment of the present disclosure;

FIG. 18 is a structural diagram of a display panel according to at least one embodiment of the present disclosure;

FIG. 19 is a structural diagram of a display panel according to at least one embodiment of the present disclosure;

FIG. 20 is a structural diagram of a pixel circuit in a display panel according to at least one embodiment of the present disclosure;

FIG. 21 is a structural diagram of at least one embodiment of the pixel circuit;

FIG. 22 is a structural diagram of at least one embodiment of the pixel circuit;

FIG. 23 is a structural diagram of at least one embodiment of the pixel circuit;

FIG. 24 is a block diagram of at least one embodiment of the pixel circuit;

FIG. 25 is a circuit diagram of at least one embodiment of the pixel circuit;

FIG. 26A is a working timing diagram of at least one embodiment of the pixel circuit shown in FIG. 25;

FIG. 26B is a working timing diagram of at least one embodiment of the pixel circuit shown in FIG. 25;

FIG. 27 is a circuit diagram of at least one embodiment of the pixel circuit;

FIG. 28 is a circuit diagram of at least one embodiment of the pixel circuit;

FIG. 29 is a circuit diagram of at least one embodiment of the pixel circuit.

### DETAILED DESCRIPTION

The technical solutions in the embodiments of the present disclosure will be clearly and completely described below with reference to the accompanying drawings in the embodiments of the present disclosure. All other embodiments obtained by a person of ordinary skill in the art based on the embodiments of the present disclosure without creative efforts shall fall within the protection scope of the present disclosure.

The transistors used in all embodiments of the present disclosure may be thin film transistors or field effect transistors or other devices with the same characteristics. In the embodiments of the present disclosure, in order to distinguish two electrodes except the gate of the transistor, one of the two electrodes is referred to as a first electrode, and the other electrode is referred to as a second electrode.

In an actual operation, when the transistor is a thin film transistor or a field effect transistor, the first electrode may be a drain electrode, and the second electrode may be a source electrode; or the first electrode may be a source electrode, and the second electrode may be a drain electrode.

The driving circuit according to an embodiment of the present disclosure includes a strobe circuit; the strobe circuit is electrically connected to the strobe control line, the data output terminal of the source driver, and the scan line, respectively, and is configured to control, under control of the strobe control signal provided by the strobe control line, the data output terminal to be connected to or disconnected from the scan line.

When the driving circuit of the embodiment of the present disclosure is in operation, the strobe circuit controls, under control of the strobe control signal provided by the strobe control line, the connection between the data output terminal and the scan line in at least part of time in blank time period between two frames of display time, and provides the scanning signal through the data output terminal, so that the transistor is controlled by the scan line to be turned on or turned off in the next frame of display time.

In a specific implementation, the scan line may extend in a vertical direction, but is not limited thereto.

In a specific implementation, when the transistor controlled by the scan line is turned off in the next frame of display time, the pixel circuit where the transistor is located does not perform data voltage writing, so that the original display brightness can be maintained through the low-leakage transistor, and waste of a part of power consumption caused by repeated flashing of the pixel circuit is avoided; when the transistor is controlled by the scan line to be turned on in the next frame of display time, the pixel circuit where the transistor is located performs data voltage writing to normally refresh the picture.

A related OLED (Organic Light Emitting Diode) display needs to perform initialization and data voltage writing on all pixel circuits within a frame of display time when updating a picture. In some special pictures (such as an AOD (Always on Display) picture, a static picture or a less updated picture), the data voltage of most of the pixel circuits in the whole screen does not need to be updated, and the original display brightness can be maintained by low-leakage LTPO (Low Temperature Polycrystalline Oxide) TFT (Thin Film Transistor), which causes power consumption waste of data line caused by repeated flashing of these pixel circuits.

Based on this, in the embodiments of the present disclosure, by designing a driving circuit, a scanning signal on the scan line may be controlled in at least in part of the blank time period between two frames of display time, so as to, according to the scanning signal, control on or off of the transistor controlled by the scan line within a next frame of display time, to control whether to refresh the data voltage of the corresponding pixel circuit, to update the local picture of the screen, and the remaining picture does not need to be charged and discharged for multiple times, thereby further reducing the power consumption of the OLED display, or realizing ultra-low power consumption by displaying the local update of the picture.

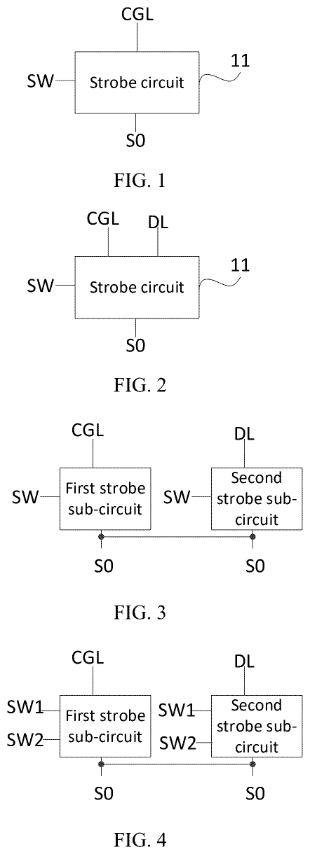

As shown in FIG. 1, the driving circuit according to an embodiment of the present disclosure includes a strobe circuit 11; the strobe circuit 11 is electrically connected to the strobe control line SW, the data output terminal S0 of the source driver, and the scan line CGL, respectively, and is configured to control the data output terminal S0 to be connected to or disconnected from the scan line CGL under control of the strobe control signal provided by the strobe control line SW.

In at least one embodiment of the present disclosure, the data output terminal is electrically connected to a data line.

In a specific implementation, the data output terminal may be directly electrically connected to the data line.

In at least one embodiment of the present disclosure, the strobe circuit is further electrically connected to a data line, and is configured to control, under control of the strobe control signal, the data output terminal to be connected to or disconnected from the data line.

In a specific implementation, the strobe circuit may further control, under control of the strobe control signal, the data output terminal to be connected to or disconnected from the data line.

In at least one embodiment of the present disclosure, at least part of time in the blank time period, a high voltage value of a scanning signal provided by the data output terminal may be greater than or equal to 7V and less than or equal to 9V, and a low voltage value of the scanning signal may be greater than or equal to −9V and less than or equal to −7V.

As shown in FIG. 2, on the basis of the embodiment of the driving circuit shown in FIG. 1, the strobe circuit 11 may further be electrically connected to the data line DL, and configured to control the data output terminal S0 to be connected to or disconnected from the data line DL under control of the strobe control signal.

In at least one embodiment of the present disclosure, the strobe circuit comprises a first strobe sub-circuit and a second strobe sub-circuit, the first strobe sub-circuit is electrically connected to the strobe control line, the data output terminal, and the scan line, respectively, and is configured to control the data output terminal to be connected to or disconnected from the scan line under control of a strobe control signal provided by the strobe control line; the second strobe sub-circuit is electrically connected to the strobe control line, the data output terminal, and the data line, respectively, and is configured to control the data output terminal to be connected to or disconnected from the data line under control of the strobe control signal.

In a specific implementation, the strobe circuit may include a first strobe sub-circuit and a second strobe sub-circuit, and the first strobe sub-circuit controls connection or disconnection between the data output terminal and the scan line under control of a strobe control signal; and the second strobe sub-circuit controls, under control of the strobe control signal, the data output terminal to be connected to or disconnected from the data line.

As shown in FIG. 3, on the basis of at least one embodiment of the driving circuit shown in FIG. 2, the strobe circuit includes a first strobe sub-circuit 31 and a second strobe sub-circuit 32; the first strobe sub-circuit 31 is electrically connected to the strobe control line SW, the data output terminal S0, and the scan line CGL, respectively, and is configured to control, under control of the strobe control signal provided by the strobe control line SW, the data output terminal S0 to be connected to or disconnected from the scan line CGL;

the second strobe sub-circuit 12 is electrically connected to the strobe control line SW, the data output terminal S0, and the data line DL, respectively, and is configured to control the data output terminal S0 to be connected to or disconnected from the data line DL under control of the strobe control signal.

In at least one embodiment of the present disclosure, the strobe control line includes a first strobe control line and a second strobe control line; the strobe circuit includes a first strobe sub-circuit and a second strobe sub-circuit;

the first strobe sub-circuit is electrically connected to the first strobe control line, the second strobe control line, the data output terminal, and the scan line, respectively, and is configured to control, under control of a first strobe control signal provided by the first strobe control line and a second strobe control signal provided by the second strobe control line, the data output terminal to be connected to or disconnected from the scan line;

the second strobe sub-circuit is electrically connected to the first strobe control line, the second strobe control line, the data output terminal, and the data line, respectively, and is configured to control the data output terminal to be connected to or disconnected from the data line under control of the first strobe control signal and the second strobe control signal.

In a specific implementation, the strobe circuit may include a first strobe sub-circuit and a second strobe sub-circuit, and the first strobe sub-circuit controls, under control of the first strobe control signal and the second strobe control signal, the data output terminal to be connected to or disconnected from the scan line; the second strobe sub-circuit controls the data output terminal to be connected to or disconnected from the data line under control of the first strobe control signal and the second strobe control signal.

As shown in FIG. 4, on the basis of at least one embodiment of the driving circuit shown in FIG. 2, the strobe circuit includes a first strobe sub-circuit 31 and a second strobe sub-circuit 32;

the first strobe sub-circuit 31 is electrically connected to the first strobe control line SW1, the second strobe control line SW2, the data output terminal S0, and the scan line CGL, respectively, and is configured to control, under control of a first strobe control signal provided by the first strobe control line SW1 and a second strobe control signal provided by the second strobe control line SW2, the data output terminal S0 to be connected to or disconnected from the scan line CGL.

The second strobe sub-circuit 32 is electrically connected to the first strobe control line SW1, the second strobe control line SW2, the data output terminal S0, and the data line DL, respectively, and is configured to control the data output terminal S0 to be connected to or disconnected from the data line DL under control of the first strobe control signal and the second strobe control signal.

Optionally, the strobe circuit includes a first transistor, and the strobe control line includes a first strobe control line; a gate electrode of the first transistor is electrically connected to the first strobe control line, a first electrode of the first transistor is electrically connected to the data output terminal, a second electrode of the first transistor is electrically connected to the scan line, and the first transistor is a P-type transistor; or the strobe circuit includes a first transistor, and the strobe control line includes a second strobe control line;
a gate electrode of the first transistor is electrically connected to the second strobe control line, a first electrode of the first transistor is electrically connected to the data output terminal, a second electrode of the first transistor is electrically connected to the scan line, and the first transistor is an N-type transistor.

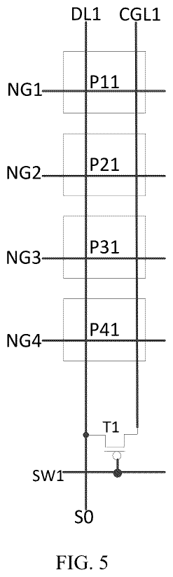

As shown in FIG. 5, a pixel circuit in a first row and a first column is numbered P11, a pixel circuit in a second row and a first column is numbered P21, a pixel circuit in a third row and the first column is numbered P31, and a pixel circuit in a fourth row and the first column is numbered P41.

A first column of data line is labeled DL1, a first column of scan lines is labeled CGL1, a first row of first gate line is numbered NG1, a first row of first gate line numbered NG1, a second row of first gate line is numbered NG2, a third row of first gate line is numbered NG3, and a fourth row of first gate line is numbered NG4;
the data output terminal S0 is directly electrically connected to the first column of data line DL1.

In at least one embodiment of the present disclosure, the driving circuit includes a strobe circuit; the strobe circuit includes a first transistor T1, and the strobe control line includes a first strobe control line SW1;

the gate electrode of T1 is electrically connected to the first strobe control line SW1, the source electrode of T1 is electrically connected to the data output terminal S0 of the source driver, and the drain electrode of T1 is electrically connected to the first column of scan lines CGL1; T1 is a P-type transistor; T1 is disposed on a lower side of each pixel circuit.

In at least one embodiment of the driving circuit shown in FIG. 5 of the present disclosure, during operation, at least part of time of a blank time period between two frames of display time, SW1 provides a low voltage signal, so that T1 is turned on, and a scanning signal is provided to the first column of scan lines CGL1 through the data output terminal S0.

During a frame of display time, SW1 provides a high voltage signal, T1 is turned off to control disconnection between the data output terminal S0 and the first column of scan lines CGL1, and a data voltage is provided for the first column of data line DL1 through the data output terminal S0.

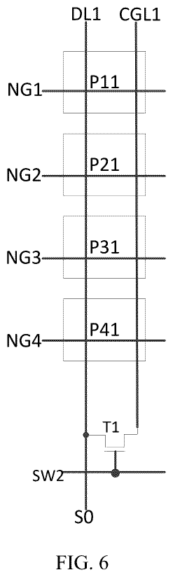

At least one embodiment of the driving circuit shown in FIG. 6 of the present disclosure differs from at least one embodiment of the driving circuit shown in FIG. 5 of the present disclosure in that: T1 is an N-type transistor; a gate of T1 is electrically connected to a second strobe control line SW2; T1 is disposed on a lower side of each pixel circuit.

In at least one embodiment of the driving circuit shown in FIG. 6 of the present disclosure, during operation, in at least part of time of a blank time period between two frames of display time, SW2 provides a high voltage signal, so that T1 is turned on, and a scanning signal is provided to the first column of scan lines CGL1 through the data output terminal S0.

During a frame of display time, SW2 provides a low voltage signal, T1 is turned off to control disconnection between the data output terminal S0 and the first column of scan lines CGL1, and a data voltage is provided for the first column of data line DL1 through the data output terminal S0.

Optionally, the strobe circuit includes a first transistor and a second transistor, and the strobe control line includes a first strobe control line;

a gate electrode of the first transistor is electrically connected to the first strobe control line, a first electrode of the first transistor is electrically connected to the data output terminal, and a second electrode of the first transistor is electrically connected to the scan line;

a gate electrode of the second transistor is electrically connected to the first strobe control line, a first electrode of the second transistor is electrically connected to the data output terminal, and a second electrode of the second transistor is electrically connected to the data line.

The first transistor is a P-type transistor, and the second transistor is an N-type transistor.

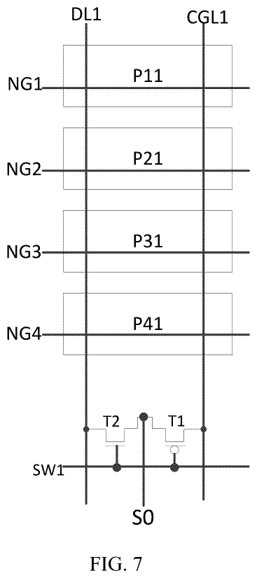

As shown in FIG. 7, a pixel circuit in a first row and in a first column is numbered P11, a pixel circuit in a second row and in a first column is numbered P21, a pixel circuit in a third row and in a first column is numbered P31, and a pixel circuit in a fourth row and in a first column is numbered P41; a first column of data line is labeled DL1, a first column of scan lines is labelled CGL1, a first row of first gate line is labelled NG1, a second row of first gate line is numbered NG2, a third row of first gate line is numbered NG3, and a fourth row of first gate line is numbered NG4.

In at least one embodiment of the present disclosure, the driving circuit includes a strobe circuit; the strobe circuit includes a first transistor T1 and a second transistor T2, and the strobe control line includes a first strobe control line SW1;

the gate of T1 is electrically connected to the first strobe control line SW1, the source of T1 is electrically connected to the data output terminal S0 of the source driver, and the drain of T1 is electrically connected to the first column of scan line CGL1; the gate of T2 is electrically connected to the first strobe control line SW1, the source of T2 is electrically connected to the data output terminal S0, and the drain of T2 is electrically connected to the first column of data line DL1; T1 is a P-type transistor, and T2 is an N-type transistor; T1 and T2 are disposed on the lower side of each pixel circuit.

In at least one embodiment shown in FIG. 7 of the present disclosure, during operation, in at least part of time in a blank time period between two frames of display time, SW1 provides a low voltage signal, and T1 is turned on to write a scan signal provided by the data output terminal S0 into the first column of scan lines CGL1;

During a frame of display time, SW1 provides a high voltage signal, T2 is turned on to control connection between the data output terminal S0 and the first column of data line DL1, and a data voltage is provided for the first column of data line DL1 through the data output terminal S0.

Optionally, the strobe circuit includes a first transistor and a second transistor, and the strobe control line includes a second strobe control line;

a gate electrode of the first transistor is electrically connected to the second strobe control line, a first electrode of the first transistor is electrically connected to the data output terminal, and a second electrode of the first transistor is electrically connected to the scan line;

a gate electrode of the second transistor is electrically connected to the second strobe control line, a first electrode of the second transistor is electrically connected to the data output terminal, and a second electrode of the second transistor is electrically connected to the data line;

The first transistor is an N-type transistor, and the second transistor is a P-type transistor.

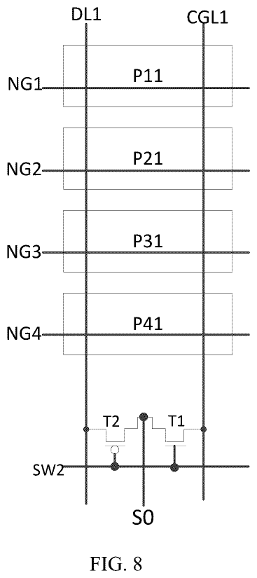

As shown in FIG. 8, a pixel circuit in the first row and in the first column is numbered P11, a pixel circuit in the second row and in the first column is numbered P21, a pixel circuit in a third row and in a first column is numbered P31, and a pixel circuit in a fourth row and in a first column is numbered P41.

A first column of data line is labeled DL1, a first row of first gate line is numbered NG1, a first row of first gate line is numbered NG1, a second row of first gate line is numbered NG2, a third row of first gate line is numbered NG3, and a fourth row of first gate line is numbered NG4; in at least one embodiment of the present disclosure, the driving circuit includes a strobe circuit; the strobe circuit includes a first transistor T1 and a second transistor T2, and the strobe control line includes a second strobe control line SW2; the gate of T1 is electrically connected to the second strobe control line SW2, the source of T1 is electrically connected to the data output terminal S0 of the source driver, and the drain of T1 is electrically connected to the first column of scan lines CGL1; the gate of T2 is electrically connected to the second strobe control line SW2, the source of T2 is electrically connected to the data output terminal S0, and the drain of T2 is electrically connected to the first column of data line DL1; T1 is an N-type transistor, and T2 is a P-type transistor; T1 and T2 are disposed on the lower side of each pixel circuit.

In at least one embodiment shown in FIG. 8 of the present disclosure, during operation, in at least part of time in a blank time period between two frames of display time, SW2 provides a high voltage signal, and T1 is turned on to write a scanning signal provided by the data output terminal S0 into the first column of scanning lines CGL1; T2 is turned off.

During a frame of display time, SW2 provides a low voltage signal, T2 is turned on to control connection between the data output terminal S0 and the first column of data line DL1, and a data voltage is provided for the first column of data line DL1 through the data output terminal S0; T1 is turned off.

In at least one embodiment of the present disclosure, the strobe control line includes a first strobe control line and a second strobe control line, the first strobe sub-circuit includes a first transistor, and the second strobe sub-circuit includes a second transistor; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a first electrode of the second transistor is electrically connected to the data output terminal, and a second electrode of the second transistor is electrically connected to the data line; both the first transistor and the second transistor are P-type transistors.

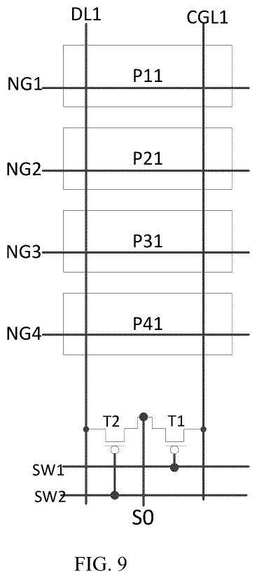

As shown in FIG. 9, a pixel circuit in a first row and in a first column is numbered P11, a pixel circuit in a second row and in a first column is numbered P21, a pixel circuit in a third row and in a first column is numbered P31, and a pixel circuit in a fourth row and in a first column is numbered P41;

A first column of data line is labeled DL1, a first row of first gate line is numbered NG1, a first row of first gate line is numbered NG1, a second row of first gate line is numbered NG2, a third row of first gate line is numbered NG3, and a fourth row of first gate line numbered NG4.

In at least one embodiment of the present disclosure, the driving circuit includes a strobe circuit, and the strobe circuit includes a first strobe sub-circuit and a second strobe sub-circuit;

the first strobe sub-circuit includes a first transistor T1 and a second strobe sub-circuit includes second transistor T2, and the strobe control line includes a first strobe control line SW1 and a second strobe control line SW2.

The gate of T1 is electrically connected to the first strobe control line SW1, the source of T1 is electrically connected to the data output terminal S0, and the drain of T1 is electrically connected to the first column of scan line CGL1; the gate of T2 is electrically connected to the second strobe control line SW2, the source of T2 is electrically connected to the data output terminal S0, and the drain of T2 is electrically connected to the first column of data line DL1; T1 and T2 are both P-type transistors; T1 and T2 are disposed on the lower side of each pixel circuit.

In at least one embodiment shown in FIG. 9 of the present disclosure, during operation, in at least part of time in a blank time period between two frames of display time, SW1 provides a low voltage signal, SW2 provides a high voltage signal, T1 is turned on to write a scanning signal provided by the data output terminal S0 into the first column of scanning lines CGL1, T2 is turned off;

During a frame of display time, SW1 provides a high voltage signal, SW2 provides a low voltage signal, T2 is turned on to control connection between the data output terminal S0 and the first column of data line DL1, a data voltage is provided for the first column of data line DL1 through the data output terminal S0, and T1 is turned off.

In at least one embodiment of the present disclosure, the strobe control line includes a first strobe control line and a second strobe control line, the first strobe sub-circuit includes a first transistor, and the second strobe sub-circuit includes a second transistor; a gate electrode of the first transistor is electrically connected to the second strobe control line, a first electrode of the first transistor is electrically connected to the data output terminal, and a second electrode of the first transistor is electrically connected to the scan line; a gate electrode of the second transistor is electrically connected to the first strobe control line, a first electrode of the second transistor is electrically connected to the data output terminal, and a second electrode of the second transistor is electrically connected to the data line; both the first transistor and the second transistor are N-type transistors.

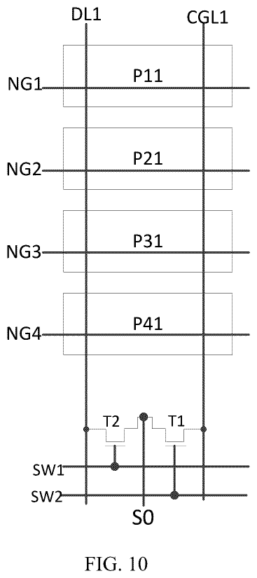

As shown in FIG. 10, a pixel circuit in a first row and in a first column is numbered P11, a pixel circuit in a second row and in a first column is numbered P21, a pixel circuit in a third row and in a first column is numbered P31, and a pixel circuit in a fourth row and in a first column is numbered P41.

A first column of data line is labeled DL1, a first column of scan liens is numbered CGL1, a first row of first gate line is numbered NG1, a second row of first gate line is numbered NG2, a third row of first gate line is numbered NG3, and a fourth row of first gate line is numbered NG4; in at least one embodiment of the present disclosure, the driving circuit includes a strobe circuit, and the strobe circuit includes a first strobe sub-circuit and a second strobe sub-circuit; the first strobe sub-circuit includes a first transistor T1 and a second strobe sub-circuit includes a second transistor T2, and the strobe control line includes a first strobe control line SW1 and a second strobe control line SW2; the gate of T1 is electrically connected to the second strobe control line SW2, the source of T1 is electrically connected to the data output terminal S0, and the drain of T1 is electrically connected to the first column of scan line CGL1; the gate of T2 is electrically connected to the first strobe control line SW1, the source of T2 is electrically connected to the data output terminal S0, and the drain of T2 is electrically connected to the first column of data line DL1; T1 and T2 are both N-type transistors; T1 and T2 are disposed on the lower side of each pixel circuit.

In at least one embodiment shown in FIG. 10 of the present disclosure, during operation, in at least part of time in a blank time period between two frames of display time, SW2 provides a high voltage signal, SW1 provides a low voltage signal, T1 is turned on to write a scanning signal provided by the data output terminal S0 into the first column of scanning lines CGL1, T2 is turned off.

During a frame of display time, SW2 provides a low voltage signal, SW1 provides a high voltage signal, T2 is turned on to control communication between the data output terminal S0 and the first column of data line DL1, a data voltage is provided for the first column of data line DL1 through the data output terminal S0, and T1 is turned off.

Optionally, the strobe circuit includes a first transistor and a second transistor, and the strobe control line includes a first strobe control line and a second strobe control line; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a second electrode of the second transistor is electrically connected to the data output terminal, and a second electrode of the first transistor is electrically connected to the scan line; the first transistor is a P-type transistor, and the second transistor is an N-type transistor.

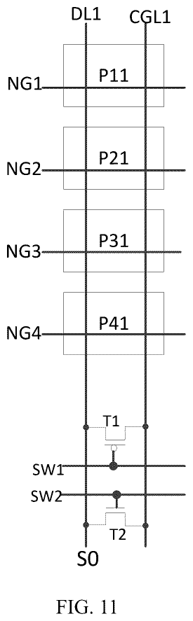

As shown in FIG. 11, a pixel circuit in a first column and in a first row is numbered P11, a pixel circuit in a second row and in first column is labeled P21, a pixel circuit in a third row and in a first column is numbered P31, and a pixel circuit in a fourth row and in a first column is numbered P41.

A first column of data line is labeled DL1, a first column of scan lines is labelled CGL1, a first row of first gate line is numbered NG1, a second row of first gate line is numbered NG2, a third row of first gate line is numbered NG3, and a fourth row of first gate line is numbered NG4.

In at least one embodiment of the present disclosure, the driving circuit includes a strobe circuit, and the strobe circuit includes a first strobe sub-circuit and a second strobe sub-circuit; the first strobe sub-circuit includes a first transistor T1, the second strobe sub-circuit includes a second transistor T2, and the strobe control line includes a first strobe control line SW1 and a second strobe control line SW2; the gate of T1 is electrically connected to the first strobe control line SW1, the source of T1 is electrically connected to the data output terminal S0, and the drain of T1 is electrically connected to the first column of scan line CGL1; the gate of T2 is electrically connected to the second strobe control line SW2, the source of T2 is electrically connected to the data output terminal S0, and the drain of T2 is electrically connected to the first column of scan lines CGL1; the data output terminal S0 is directly electrically connected to the first column data line DL1; T1 is a P-type transistor, and T2 is an N-type transistor; T1 and T2 are disposed on the lower side of each pixel circuit.

In at least one embodiment shown in FIG. 11 of the present disclosure, during operation, in at least part of time in a blank time period between two frames of display time, SW1 provides a low voltage signal, SW2 provides a high voltage signal, and T1 and T2 are turned on to write a scan signal provided by the data output terminal S0 into the first column of scan lines CGL1; during a frame of display time, SW1 provides a high voltage signal, SW2 provides a low voltage signal, T1 and T2 are turned off, the data output terminal S0 is disconnected from the first column of scan lines CGL1, and a data voltage is provided for the first column of data line DL1 through the data output terminal S0.

In at least one embodiment of the present disclosure, the strobe control line includes a first strobe control line and a second strobe control line; the first strobe control sub-circuit includes a first transistor and a second transistor, and the second strobe control sub-circuit includes a third transistor and a fourth transistor; a gate electrode of the first transistor is electrically connected to the first strobe control line, a first electrode of the first transistor is electrically connected to the data output terminal, and a second electrode of the first transistor is electrically connected to the scan line; a gate electrode of the second transistor is electrically connected to the second strobe control line, a first electrode of the second transistor is electrically connected to the data output terminal, and a second electrode of the second transistor is electrically connected to the scan line; a gate electrode of the third transistor is electrically connected to the first strobe control line, a first electrode of the third transistor is electrically connected to the data output terminal, and a second electrode of the third transistor is electrically connected to the data line; a gate electrode of the fourth transistor is electrically connected to the second strobe control line, a first electrode of the fourth transistor is electrically connected to the data output terminal, and a second electrode of the fourth transistor is electrically connected to the data line; the first transistor and the fourth transistor are P-type transistors, and the second transistor and the third transistor are N-type transistors.

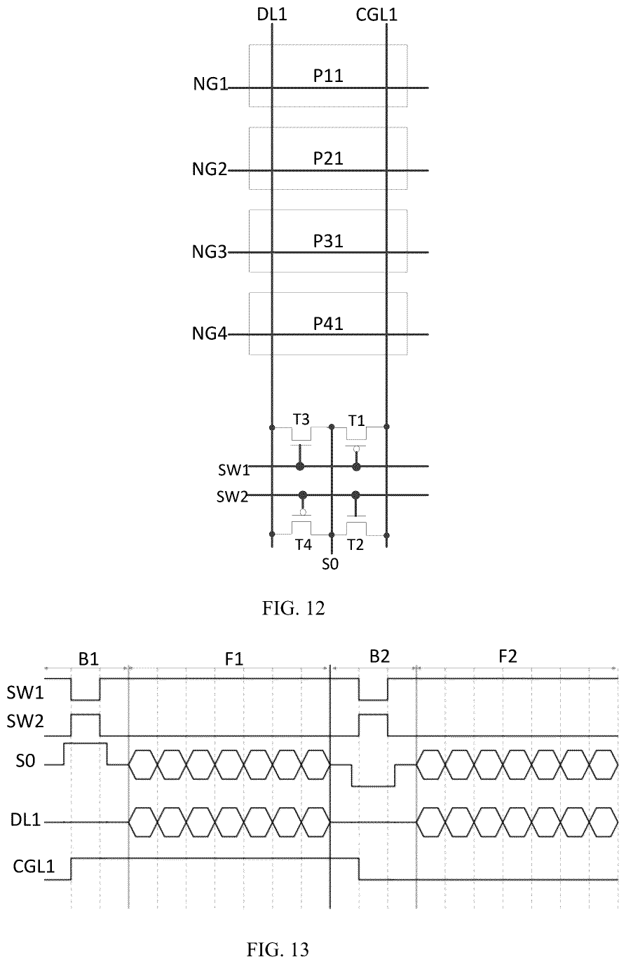

As shown in FIG. 12, a pixel circuit in a first row and in a first column is numbered P11, a pixel circuit in a second row and in a first column is numbered P21, a pixel circuit in a third row and in a first column is numbered P31, and a pixel circuit in a fourth row and in a first column is numbered P41; a first column of data line is labeled DL1, a first column of scan lines is numbered CGL1, a first row of first gate line is numbered NG1, a first row of first gate line is numbered NG2, a third row of first gate line is numbered NG3, and a fourth row of first gate line is numbered NG4.

In at least one embodiment of the present disclosure, the driving circuit includes a strobe circuit, and the strobe circuit includes a first strobe sub-circuit and a second strobe sub-circuit. The first strobe sub-circuit includes a first transistor T1 and a second transistor T2, the second strobe sub-circuit includes a third transistor T3 and a fourth transistor T4, and the strobe control line includes a first strobe control line SW1 and a second strobe control line SW2; the gate of T1 is electrically connected to the first strobe control line SW1, the source of T1 is electrically connected to the data output terminal S0, and the drain of T1 is electrically connected to the first column of scan line CGL1; the gate of T2 is electrically connected to the second strobe control line SW2, the source of T2 is electrically connected to the data output terminal S0, and the drain of T2 is electrically connected to the first column of scan lines CGL1; the gate of T3 is electrically connected to the first strobe control line SW1, the source of T3 is electrically connected to the data output terminal S0, and the drain of T3 is electrically connected to the first column of data line DL1; the gate of T4 is electrically connected to the second strobe control line SW2, the source of T4 is electrically connected to the data output terminal S0, and the drain of T4 is electrically connected to the first column of data line DL1.

T1 and T4 are P-type transistors, and T2 and T3 are N-type transistors; T1, T2, T3, and T4 are disposed on the lower side of each pixel circuit.

In at least one embodiment shown in FIG. 12 of the present disclosure, during operation, in at least part of time in a blank time period between two frames of display time, SW1 provides a low voltage signal, SW2 provides a high voltage signal, and T1 and T2 are turned on to write a scan signal provided by the data output terminal S0 into the first column of scan lines CGL1; T3 and T4 are turned off.

During a frame of display time, SW1 provides a high voltage signal, SW2 provides a low voltage signal, T3 and T4 are turned on, T1 and T2 are turned off, the data output terminal S0 is disconnected from the first column of scan lines CGL1, and a data voltage is provided for the first column of data line DL1 through the data output terminal S0.

As shown in FIG. 13, during operation in at least one embodiment shown in FIG. 12 of the present disclosure, in some time intervals included in the first blank time period B1, SW1 provides a low voltage signal, SW2 provides a high voltage signal, T1 and T2 are turned on, and S0 provides a high voltage signal to the first column of scan lines CGL1; T3 and T4 are turned off.

In the first frame of display time f1, CGL1 continuously provides a high voltage signal;

At the first frame of display time f1, SW1 provides a high voltage signal, SW2 provides a low voltage signal, T3 and T4 are turned on, and S0 provides a data voltage to the first column of data line DL1; T1 and T2 are turned off.

In some time intervals included in the second blank time period B2, SW1 provides a low voltage signal, SW2 provides a high voltage signal, T1 and T2 are turned on, and S0 provides a low voltage signal to the first column of scan lines CGL1; T3 and T4 are turned off; in the second frame of display time f2, the CGL1 continuously provides a low voltage signal; in the second frame of display time f2, SW1 provides a high voltage signal, SW2 provides a low voltage signal, T3 and T4 are turned on, S0 provides a data voltage to the first column of data line DL1, and T1 and T2 are turned off.

In FIG. 13, in the first blank time period B1 and the first frame of display time F1, the potential of the high voltage signal output by the CGL1 is greater than or equal to 7 V and less than or equal to 9 V; in the second blank time period B2 and the second frame of display time F2, the potential of the low voltage signal output by the CGL1 is greater than or equal to −9 V and less than or equal to −7 V.

In at least one embodiment shown in FIG. 5 to at least one embodiment shown in FIG. 12, the source driver may be disposed on a lower side of each pixel circuit, and the driving circuit is disposed on a lower side of each of the pixel circuits.

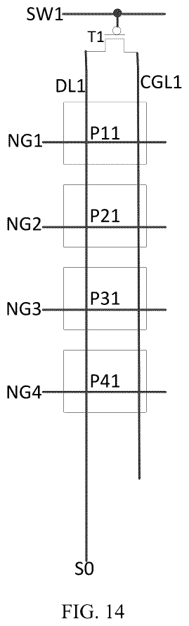

At least one embodiment of the driving circuit shown in FIG. 14 differs from at least one embodiment of the driving circuit shown in FIG. 5 in that: T1 is disposed on an upper side of each pixel circuit.

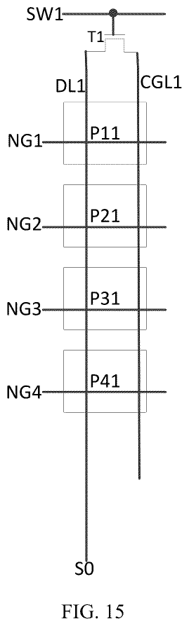

At least one embodiment of the driving circuit shown in FIG. 15 differs from at least one embodiment of the driving circuit shown in FIG. 6 in that: T1 is disposed on an upper side of each pixel circuit.

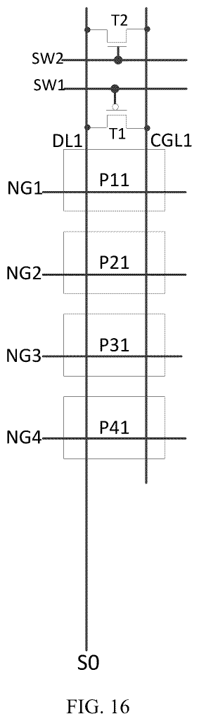

At least one embodiment of the driving circuit shown in FIG. 16 differs from at least one embodiment of the driving circuit shown in FIG. 11 in that T1 and T2 are disposed on the upper side of each pixel circuit.

The driving method according to the embodiments of the present disclosure is applied to the driving circuit, and the driving method includes: in at least part of time in a blank time period between two frames of display time, under control of the strobe control signal provided by the strobe control line, controlling, by the strobe circuit, communication between the data output terminal and the scan line.

In the driving method according to the embodiment of the present disclosure, the scanning signal on the scan line may be controlled in at least part of the blank time period between two frames of display time, so as to control the on or off of the transistor controlled by the scan line in the next frame of display time according to the scanning signal, and control whether to refresh the data voltage of the corresponding pixel circuit according to the scanning signal, so as to update the local picture of the screen, and the remaining picture does not need to be charged and discharged for multiple times, thereby further reducing the power consumption of the OLED display, or realizing ultra-low power consumption by displaying the local update of the picture.

In at least one embodiment of the present disclosure, the data output terminal is electrically connected to a data line, and the driving method further includes: during a data writing time period in a frame of display time, providing, by the data output terminal, a data voltage to a data line electrically connected to the data output terminal.

In at least one embodiment of the present disclosure, the strobe circuit is further electrically connected to a data line, and the driving method further includes: in a data writing time period in a frame of display time, under control of the strobe control signal, controlling, by the strobe circuit, the data output terminal to be connected to the data line, so that the data output terminal provides a data voltage to the data line.

The display panel according to an embodiment of the present disclosure includes a source driver, a plurality of columns of scan lines, and the above drive circuit; the source driver includes a plurality of data output terminals; the strobe circuit included in the driving circuit is electrically connected to the strobe control line, the data output terminal, and the scan line, respectively, and is configured to control the data output terminal to be connected to or disconnected from the scan line under control of a strobe control signal provided by the strobe control line.

In a specific implementation, the display panel may include a source driver, a plurality of columns of scan lines, and the driving circuit, and the strobe circuit included in at least part of the time in the blank time period between the two frames of display time, controlling, by the strobe circuit included in the driving circuit, the data output terminal to be connected with the scan line under control of the strobe control signal, and under control of the strobe control signal, controlling, by the strobe circuit, the data output terminal to be disconnected from the scan line in a frame of display time.

In at least one embodiment of the present disclosure, the display panel further comprises a plurality of columns of pixel circuits; a column of scan lines is electrically connected to a column of the pixel circuits, respectively.

In at least one embodiment of the present disclosure, the display panel comprises a plurality of columns of data lines, and the data output terminal is directly electrically connected to the data lines; or the strobe circuit is further electrically connected to the data line, and is configured to control, under control of the strobe control signal, the data output terminal to be connected to or disconnected from the data line.

In at least one embodiment of the present disclosure, the source driver is disposed on a first side edge of the display panel, and the driving circuit is disposed on a first side edge of the display panel; or the source driver is disposed on a first side edge of the display panel, the driving circuit is disposed on a second side edge of the display panel, and the first side edge and the second side edge are opposite side edges.

For example, the first side edge may be a lower side edge, and the second side edge may be an upper side edge, but is not limited thereto.

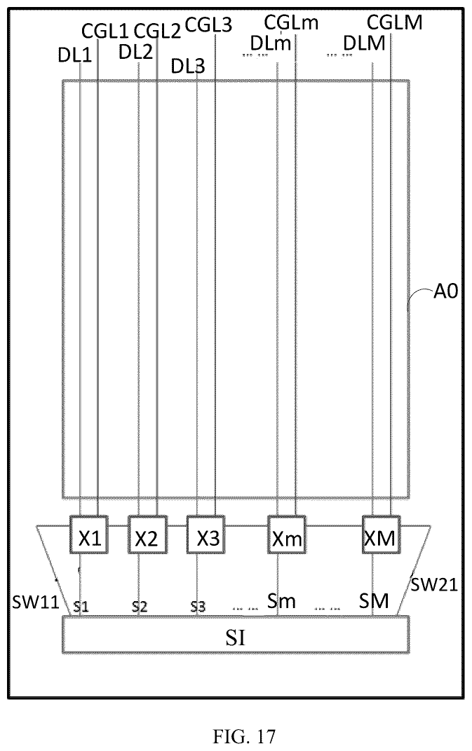

As shown in FIG. 17, a display area of a display panel is labeled A0; the first column of data line is labeled DL1, the first column of scan lines is numbered as CGL1, the second column of data lines is labeled DL2, and the second column of scan lines is numbered CGL2; the third column of data lines is labeled DL3, the third column of scan lines is numbered as CGL3, the m-th column of data line is labeled DLm, the m-th column of scan lines is numbered as CGLm, the m-th column of data line is labeled DLM, and the m-th column of scan lines is numbered as CGLM;

m and M are both positive integers; the source driver is numbered SI; a first data output terminal of the source driver SI is labelled SI, a second data output terminal of the source driver SI is labelled s2, a third data output terminal of a source driver SI is labelled S3, an m-th data output terminal of the source driver SI is labelled Sm, and an M-th data output terminal of the source driver SI is labelled SM.

A first first strobe control line is labelled SW11, and a second first strobe control line is labelled SW21; the source driver SI is electrically connected to SW11 and SW21, and is configured to provide a first first strobe control signal for SW11, and provide a second first strobe control signal for SW21;

In FIG. 17, the first driving circuit is labelled X1, the second driving circuit is labeled X2, the third driving circuit is labeled X3, the m-th driving circuit is labeled Xm, and the M-th driving circuit is labelled XM; X1 is electrically connected to DL1 and CGL1 respectively, X2 is electrically connected to DL2 and CGL2, X3 is electrically connected to DL3 and CGL3, respectively, Xm is electrically connected to DLm and CGLm, respectively, and XM is electrically connected to DLM and CGLM, respectively;

The source driver SI is disposed below the display area A0, and the first driving circuit X1, the second driving circuit X2, the third driving circuit X3, the m-th driving circuit Xm, and the M-th driving circuit XM are disposed below the display area A0.

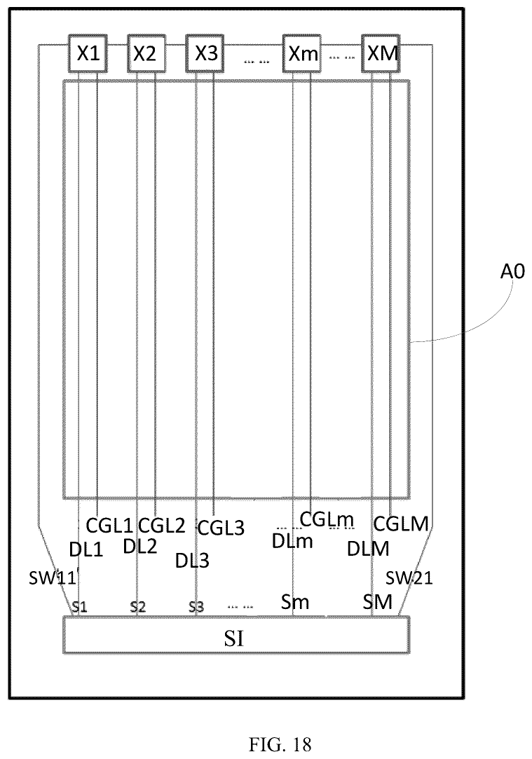

At least one embodiment of the display panel shown in FIG. 18 differs from at least one embodiment of the display panel shown in FIG. 17 in that: the first driving circuit X1, the second driving circuit X2, the third driving circuit X3, the m-th driving circuit Xm, and the M-th driving circuit XM are disposed above A0.

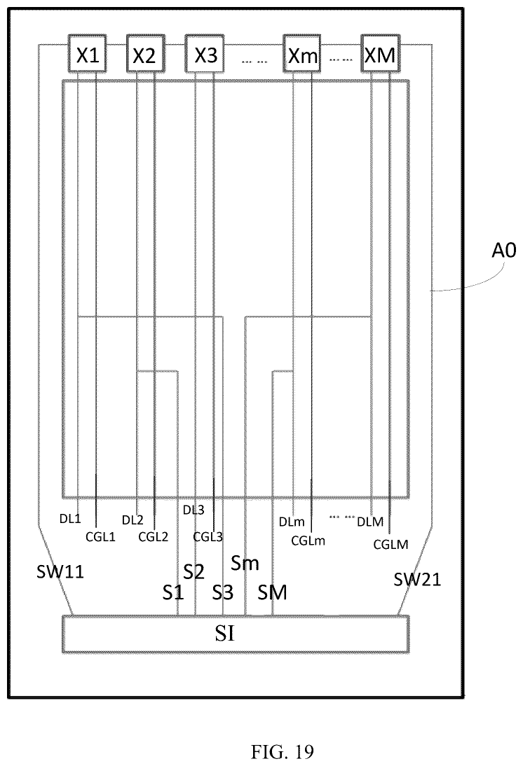

At least one embodiment of the display panel shown in FIG. 19 differs from at least one embodiment of the display panel shown in FIG. 18 in that: each data output terminal of the source driver SI is concentrated in the middle of the display panel to implement a lower narrow bezel, and at least one embodiment of the display panel shown in FIG. 19 is combined with an FIP (Fanout In Pixel) embodiment.

Embodiments of the present disclosure provide a driving solution applied to an OLED display, in which a local refresh pixel circuit cooperates with a source driving circuit and a driving solution, and an HCT control signal (the HCT control signal may be a data signal provided by a data output terminal of the source driver in a blank time period) is used to update a local picture of the screen, while the remaining images do not need to be charged and discharged for multiple times, thereby further reducing power consumption of the OLED display, or realizing ultra-low power consumption by means of local updating of a display picture.

In at least one embodiment of the present disclosure, for a display device, when a part of a picture needs to be updated, for example, only a date and a time part need to be updated. In the row direction, whether the gate driving circuit is output may be controlled: when the row of the picture needs to be updated, the first gate driving signal is normally output, the first control transistor in the pixel circuit in the display area is controlled to be normally turned on, and data updating is performed; and the potential of the first gate driving signal is always kept to turn off the first control transistor without updating the row of the picture, so as to ensure that the brightness of the pixel is unchanged, thereby implementing local refreshing in the row direction. In the column direction, the second control transistor in the pixel circuit can be controlled by controlling whether the column of scan lines turns on the second control transistor in the pixel circuit, the source driver outputs the HCT Pulse (pulse), and different scan signals are written into the column of scan lines in the blank time period of two frames of display time, and if the current column needs to be updated, the column of scan lines needs to ensure that the second control transistor is always on, so that the current column can be normally refreshed. If some columns do not need to be updated, the column of scan lines need to ensure that the second control transistors in these column of pixel circuits are always turned off.

In at least one embodiment of the present disclosure, the pixel circuit may include a light-emitting element, a light-emitting driving circuit, and a control circuit; the light-emitting driving circuit is electrically connected to the first node, the second node, and the third node, respectively, and is configured to generate a driving current flowing through the second node and the third node under control of the potential of the first node; the light-emitting element is electrically connected to the third node; the control circuit is electrically connected to the first gate line, the scan line, the first node, and the third node, respectively, and is configured to control the first node to be connected to or disconnected from the third node under control of a first gate driving signal provided by the first gate line and a scanning signal provided by the scan line.

In a specific implementation, the pixel circuit may include a control circuit and a light-emitting driving circuit, the light-emitting driving circuit generates a driving current under control of the potential of the first node, and the control circuit controls the first node to be connected to or disconnected from the third node under control of a first gate driving signal provided by the first gate line and a scanning signal provided by the scan line; and the driving current may be a current for driving the light-emitting element to emit light.

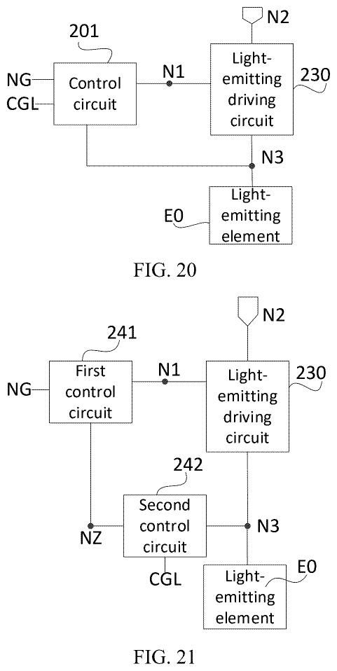

As shown in FIG. 20, the pixel circuit may include a light-emitting element E0, a control circuit 201, and a light-emitting driving circuit 230; the light-emitting driving circuit 200 is electrically connected to the first node N1, the second node N2, and the third node N3, respectively, and is configured to generate a driving current flowing through the second node N2 and the third node N3 under control of the potential of the first node N1; the light-emitting element B0 is electrically connected to the third node N3; the control circuit 201 is electrically connected to the first gate line NG, the scan line CGL, the first node N1, and the third node N3, respectively, and is configured to control the first node N1 to be connected to or disconnected from the third node N3 under control of a first gate driving signal provided by the first gate line NG and a scanning signal provided by the scan line CGL.

Optionally, the control circuit includes a first control circuit and a second control circuit; the first control circuit is electrically connected to the first gate line, the first node, and the intermediate node, respectively, and the first control circuit is configured to control the first node to be connected to or disconnected from the intermediate node under control of a first gate driving signal provided by the first gate line; the second control circuit is electrically connected to the scan line, the intermediate node, and the third node, respectively, and is configured to control the intermediate node to be connected to or disconnected from the third node under control of a scanning signal provided by the scan line.

In a specific implementation, the control circuit may include a first control circuit and a second control circuit, the first control circuit controls the first node to be connected to or disconnected from the intermediate node under control of a first gate driving signal provided by the first gate line, and the second control circuit controls the intermediate node to be connected to or disconnected from the third node under control of a scanning signal provided by the scan line.

As shown in FIG. 21, on the basis of at least one embodiment of the pixel circuit shown in FIG. 20, the control circuit includes a first control circuit 241 and a second control circuit 242; the first control circuit 241 is electrically connected to the first gate line NG, the first node N1, and the intermediate node NZ, respectively, and is configured to control, under control of the first gate driving signal provided by the first gate line NG, the first node N1 to be connected to or disconnected from the intermediate node NZ; the second control circuit 242 is electrically connected to the scan line CGL, the intermediate node NZ, and the third node N3, respectively, and is configured to control the intermediate node NZ to be connected to or disconnected from the third node N3 under control of a scan signal provided by the scan line CGL.

Optionally, the control circuit includes a first control circuit and a second control circuit; the first control circuit is electrically connected to the first gate line, the third node, and the intermediate node, respectively, and is configured to control the third node to be connected to or disconnected from the intermediate node under control of a first gate driving signal provided by the first gate line; the second control circuit is electrically connected to the scan line, the intermediate node, and the first node, respectively, and is configured to control the intermediate node to be connected to or disconnected from the first node under control of a scan signal provided by the scan line.

In a specific implementation, the control circuit may include a first control circuit and a second control circuit, and the first control circuit controls the third node to be connected to or disconnected from the intermediate node under control of a first gate driving signal provided by the first gate line; and the second control circuit controls the intermediate node to be connected to or disconnected from the first node under control of a scanning signal provided by the scan line.

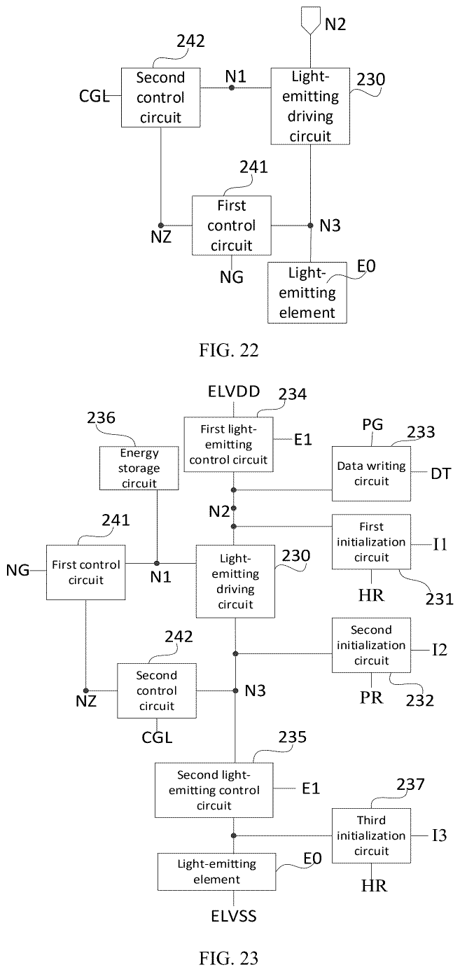

As shown in FIG. 22, on the basis of at least one embodiment of the pixel circuit shown in FIG. 20, the control circuit includes a first control circuit 241 and a second control circuit 242; the first control circuit 241 is electrically connected to the first gate line NG, the third node N3, and the intermediate node NZ, respectively, and is configured to control, under control of the first gate driving signal provided by the first gate line NG, the third node N3 to be connected to or disconnected from the intermediate node NZ; the second control circuit 242 is electrically connected to the scan line CGL, the intermediate node NZ, and the first node N1, respectively, and is configured to control, under control of a scan signal provided by the scan line CGL, the intermediate node NZ to be connected to or disconnected from the first node N1.

Optionally, the light-emitting element may be an organic light-emitting diode, but is not limited thereto. In actual operation, the light-emitting element may also be another type of light-emitting diode.

In at least one embodiment of the present disclosure, the pixel circuit may further include a first initialization circuit; the first initialization circuit is electrically connected to the first initial control terminal, the first initial voltage terminal, and the second node, respectively, and is configured to write the first initial voltage, provided by the first initial voltage terminal, into the second node under control of the first initial control signal provided by the first initial control terminal.

During specific implementation, the display period may include a first initialization time period and a second initialization time period that are sequentially set; in the first initialization time period, the control circuit controls the first node to be connected to the third node under control of the first gate driving signal and the scanning signal; the first initialization circuit writes a first initial voltage into the second node under control of the first initial control signal; and the light-emitting driving circuit controls the second node to be connected with the third node under control of the potential of the first node; in the second initialization time period, the control circuit controls the first node to be disconnected from the third node under control of the first gate driving signal and the scanning signal; the first initialization circuit writes the first initial voltage into the second node under control of the first initial control signal; and the light-emitting driving circuit controls the second node to be connected with the third node under control of the potential of the first node.

During operation of the pixel circuit according to at least one embodiment of the present disclosure, during the first initialization time period, the potentials of the first node, the second node and the third node are initialized before the data is written, so as to reduce the subsequent charging difference, and in the second initialization time period, the first initialization circuit writes the first initial voltage into the second node, and the light-emitting driving circuit controls the second node to be connected with the third node, so that the driving transistor included in the light-emitting driving circuit is in a bias state, and the hysteresis phenomenon can be improved.

Optionally, the pixel circuit may further include a second initialization circuit; the second initialization circuit is electrically connected to the second initial control terminal, the second initial voltage terminal, and the third node, respectively, and is configured to write a second initial voltage, provided by the second initial voltage terminal, into the third node under control of a second initial control signal provided by the second initial control terminal.

In a specific implementation, the pixel circuit may further include a second initialization circuit;

In a third initialization time period set between the first initialization time period and the second initialization time period, before the data writing time period, the second initialization circuit writes the second initial voltage into the third node under control of the second initial control signal, so that when the data writing time period starts, the driving transistor included in the light-emitting driving circuit can be turned on, thereby facilitating data voltage writing and threshold voltage compensation.

The pixel circuit according to at least one embodiment of the present disclosure may further include a data writing circuit, a first light-emitting control circuit, a second light-emitting control circuit, and an energy storage circuit; the data writing circuit is electrically connected to the second gate line, the data line, and the second node, respectively, and is configured to write a data voltage, provided by the data line, into the second node under control of a second gate driving signal provided by the second gate line; and the first light-emitting control circuit is electrically connected to the light-emitting control line, the power supply voltage terminal, and the second node, respectively, and is configured to control, under control of the light-emitting control signal provided by the light-emitting control line, the power supply voltage terminal to be connected to or disconnected from the second node; the second light-emitting control circuit is electrically connected to the light-emitting control line, the third node, and a first electrode of the light-emitting element, and configured to control, under control of the light-emitting control signal, the third node to be electrically connected to a first electrode of the light-emitting element, and a second electrode of the light-emitting element is electrically connected to a third voltage terminal; the energy storage circuit is electrically connected to the first node and configured to store electric energy.

In a specific implementation, the pixel circuit may further include a data writing circuit, a first light-emitting control circuit, a second light-emitting control circuit, and an energy storage circuit; and the data writing circuit is configured to write a data voltage to the second node, the first light-emitting control circuit and the second light-emitting control circuit are configured to control to enable the light-emitting path to be communicated, and the energy storage circuit is configured to store electric energy.

Optionally, the third voltage terminal may be a low-level terminal or a ground terminal, but is not limited thereto.

In at least one embodiment of the present disclosure, the pixel circuit may further include a third initialization circuit; the third initialization circuit is electrically connected to the first initial control terminal, the third initial voltage terminal, and the first electrode of the light-emitting element, respectively, and is configured to write a third initial voltage, provided by the third initial voltage terminal, into the first electrode of the light-emitting element under control of the first initial control signal provided by the first initial control terminal.

In a specific implementation, the pixel circuit may further include a third initialization circuit, and the third initialization circuit writes the third initial voltage into the first electrode of the light-emitting element under control of the first initial control signal, so as to control the light-emitting element not to emit light and clear the residual charge of the first electrode of the light-emitting element.

Optionally, the first control circuit includes a first control transistor, and the second control circuit includes a second control transistor; a gate electrode of the first control transistor is electrically connected to the first gate line, a first electrode of the first control transistor is electrically connected to the first node, and a second electrode of the first control transistor is electrically connected to the intermediate node; a gate electrode of the second control transistor is electrically connected to the scan line, a first electrode of the second control transistor is electrically connected to the intermediate node, and a second electrode of the second control transistor is electrically connected to the third node.

Optionally, the first control circuit includes a first control transistor, and the second control circuit includes a second control transistor; a gate electrode of the first control transistor is electrically connected to the first gate line, a first electrode of the first control transistor is electrically connected to the intermediate node, and a second electrode of the first control transistor is electrically connected to the third node; a gate electrode of the second control transistor is electrically connected to the scan line, a first electrode of the second control transistor is electrically connected to the first node, and a second electrode of the second control transistor is electrically connected to the intermediate node.

Optionally, the first initialization circuit includes a first initialization transistor; a gate of the first initialization transistor is electrically connected to the first initial control terminal, a first electrode of the first initialization transistor is electrically connected to the first initial voltage terminal, and a second electrode of the first initialization transistor is electrically connected to the second node.

Optionally, the second initialization circuit includes a second initialization transistor; a gate electrode of the second initialization transistor is electrically connected to the second initial control terminal, a first electrode of the second initialization transistor is electrically connected to the second initial voltage terminal, and a second electrode of the second initialization transistor is electrically connected to the third node.

Optionally, the data writing circuit includes a writing transistor, the first light-emitting control circuit includes a first light-emitting control transistor, and the second light-emitting control circuit includes a second light-emitting control transistor; the light-emitting driving circuit includes a driving transistor, and the energy storage circuit includes a storage capacitor; a gate electrode of the write transistor is electrically connected to the second gate line, a first electrode of the write transistor is electrically connected to the data line, and a second electrode of the write transistor is electrically connected to the second node; a gate electrode of the first light-emitting control transistor is electrically connected to the light-emitting control line, a first electrode of the first light-emitting control transistor is electrically connected to the power supply voltage terminal, and a second electrode of the first light-emitting control transistor is electrically connected to the second node; a gate electrode of the second light-emitting control transistor is electrically connected to the light-emitting control line, a first electrode of the second light-emitting control transistor is electrically connected to the third node, and a second electrode of the second light-emitting control transistor is electrically connected to a first electrode of the light-emitting element; a gate electrode of the driving transistor is electrically connected to the first node, a first electrode of the driving transistor is electrically connected to the second node, and a second electrode of the driving transistor is electrically connected to the third node.

A first end of the storage capacitor is electrically connected to the first node, and a second end of the storage capacitor is electrically connected to the power supply voltage terminal.

Optionally, the third initialization circuit includes a third initialization transistor; a gate electrode of the third initialization transistor is electrically connected to the first initial control terminal, a first electrode of the third initialization transistor is electrically connected to the third initial voltage terminal, and a second electrode of the third initialization transistor is electrically connected to a first electrode of the light-emitting element.

As shown in FIG. 23, on the basis of at least one embodiment of the pixel circuit shown in FIG. 21, the pixel circuit according to at least one embodiment of the present disclosure may further include a first initialization circuit 231, a second initialization circuit 232, a data write circuit 233, a first light emission control circuit 234, a second light emission control circuit 235, an energy storage circuit 236, and a third initialization circuit 237.

The first initialization circuit 231 is electrically connected to the first initial control terminal HR, the first initial voltage terminal I1, and the second node N2, respectively, and is configured to write the first initial voltage Vinit1, provided by the first initial voltage terminal I1, into the second node N2 under control of a first initial control signal provided by the first initial control terminal HR; the second initialization circuit 232 is electrically connected to the second initial control terminal PR, the second initial voltage terminal 12, and the third node N3, respectively, and is configured to write the second initial voltage Vinit2, provided by the second initial voltage terminal 12, into the third node N3 under control of a second initial control signal provided by the second initial control terminal PR.

The data writing circuit 233 is electrically connected to the second gate line PG, the data line DT, and the second node N2, respectively, and is configured to write the data voltage Vdata, provided by the data line DT, into the second node N2 under control of the second gate driving signal provided by the second gate line PG.

The first light-emitting control circuit 234 is electrically connected to the light-emitting control line E1, the power supply voltage terminal ELVDD, and the second node N2, respectively, and is configured to control, under control of the light-emitting control signal provided by the light-emitting control line E1, the power supply voltage terminal ELVDD to be connected to or disconnected from the second node N2.

The second light-emitting control circuit 235 is electrically connected to the light-emitting control line E1, the third node N3, and the first electrode of the light-emitting element E0, respectively, and is configured to control, under control of the light-emitting control signal, the third node N3 to be electrically connected to the first electrode of the light-emitting element E0, and the second electrode of the light-emitting element E0 is electrically connected to the third voltage terminal V3.

The energy storage circuit 236 is electrically connected to the first node N1, and is configured to store electric energy

The third initialization circuit 237 is electrically connected to the first initial control terminal HR, the third initial voltage terminal 13, and the first electrode of the light-emitting element E0, respectively, and is configured to write the third initial voltage Vinit 3 provided by the third initial voltage terminal 13 into the first electrode of the light-emitting element E0 under control of the first initial control signal provided by the first initial control terminal HR.

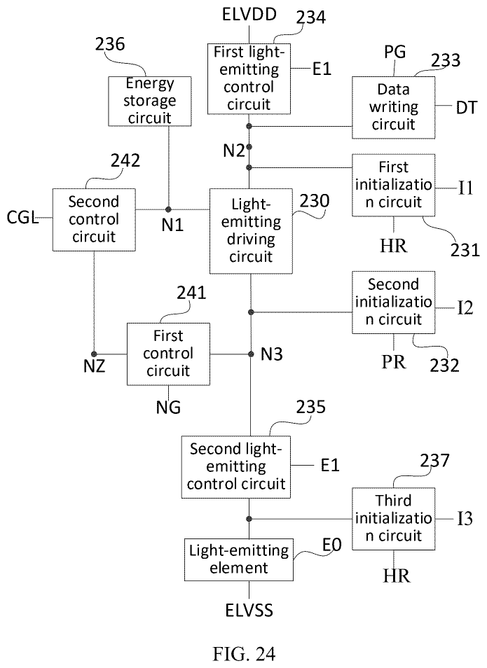

As shown in FIG. 24, on the basis of at least one embodiment of the pixel circuit shown in FIG. 22, the pixel circuit according to at least one embodiment of the present disclosure may further include a first initialization circuit 231, a second initialization circuit 232, a data write circuit 233, a first light emission control circuit 234, a second light emission control circuit 235, an energy storage circuit 236, and a third initialization circuit 237.

The first initialization circuit 231 is electrically connected to the first initial control terminal HR, the first initial voltage terminal I1, and the second node N2, respectively, and is configured to write the first initial voltage Vinit1, provided by the first initial voltage terminal I1, into the second node N2 under control of a first initial control signal provided by the first initial control terminal HR; the second initialization circuit 232 is electrically connected to the second initial control terminal PR, the second initial voltage terminal 12, and the third node N3, respectively, and is configured to write the second initial voltage Vinit2, provided by the second initial voltage terminal 12, into the third node N3 under control of a second initial control signal provided by the second initial control terminal PR.

The data writing circuit 233 is electrically connected to the second gate line PG, the data line DT, and the second node N2, respectively, and is configured to write the data voltage Vdata, provided by the data line DT, into the second node N2 under control of the second gate driving signal provided by the second gate line PG.

The first light-emitting control circuit 234 is electrically connected to the light-emitting control line E1, the power supply voltage terminal ELVDD, and the second node N2, respectively, and is configured to control, under control of the light-emitting control signal provided by the light-emitting control line E1, the power supply voltage terminal ELVDD to be connected to or disconnected from the second node N2.

The second light-emitting control circuit 235 is electrically connected to the light-emitting control line E1, the third node N3, and the first electrode of the light-emitting element E0, respectively, and is configured to control, under control of the light-emitting control signal, the third node N3 to be electrically connected to the first electrode of the light-emitting element B0, and the second electrode of the light-emitting element E0 is electrically connected to the third voltage terminal V3.

The energy storage circuit 236 is electrically connected to the first node N1, and is configured to store electric energy.

The third initialization circuit 237 is electrically connected to the first initial control terminal HR, the third initial voltage terminal 13, and the first electrode of the light-emitting element E0, respectively, and is configured to write the third initial voltage Vinit3, provided by the third initial voltage terminal 13, into the first electrode of the light-emitting element E0 under control of the first initial control signal provided by the first initial control terminal HR.

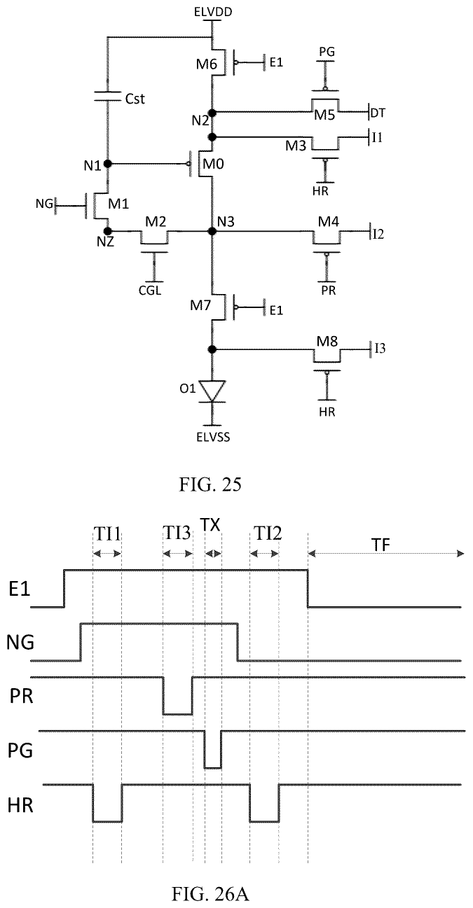

As shown in FIG. 25, on the basis of at least one embodiment of the pixel circuit shown in FIG. 23, the first control circuit includes a first control transistor M1, the second control circuit includes a second control transistor M2, and the light-emitting driving circuit includes a driving transistor M0.

A gate electrode of the first control transistor M1 is electrically connected to the first gate line NG, a source electrode of the first control transistor M1 is electrically connected to the first node N1, and a second electrode of the first control transistor M1 is electrically connected to the intermediate node NZ.

A gate electrode of the second control transistor M2 is electrically connected to the scan line CGL, a source electrode of the second control transistor M2 is electrically connected to the intermediate node NZ, and a drain electrode of the second control transistor M2 is electrically connected to the third node N3.

A gate electrode of the driving transistor M0 is electrically connected to the first node N1, a source electrode of the driving transistor M0 is electrically connected to the second node N2, and a drain electrode of the driving transistor M0 is electrically connected to the third node N3; the first initialization circuit includes a first initialization transistor M3; a gate of the first initialization transistor M3 is electrically connected to the first initial control terminal HR, a source of the first initialization transistor M3 is electrically connected to the first initial voltage terminal I1, a drain of the first initialization transistor M3 is electrically connected to the second node N2, and the first initial voltage terminal I1 is configured to provide a first initial voltage Vinit1.

The second initialization circuit includes a second initialization transistor M4, a gate electrode of the second initialization transistor M4 is electrically connected to the second initial control terminal PR, a source electrode of the second initialization transistor M4 is electrically connected to the second initial voltage terminal 12, a drain electrode of the second initialization transistor M4 is electrically connected to the third node N3, and the second initial voltage terminal 12 is configured to provide a second initial voltage Vinit2.

The data writing circuit includes a writing transistor M5, the first light-emitting control circuit includes a first light-emitting control transistor M6, and the second light-emitting control circuit includes a second light-emitting control transistor M7; the energy storage circuit includes a storage capacitor Cst; the light emitting element is an organic light emitting diode O1.

A gate electrode of the write transistor M5 is electrically connected to the second gate line PG, a source electrode of the write transistor M5 is electrically connected to the data line DT, and a drain electrode of the write transistor M5 is electrically connected to the second node N2.

A gate electrode of the first light-emitting control transistor M6 is electrically connected to the light-emitting control line E1, a source electrode of the first light-emitting control transistor M6 is electrically connected to the power voltage terminal ELVDD, and a drain electrode of the first light-emitting control transistor M6 is electrically connected to the second node N2.

A gate electrode of the second light-emitting control transistor M7 is electrically connected to the light-emitting control line E1, a source electrode of the second light-emitting control transistor M7 is electrically connected to the third node N3, and a drain electrode of the second light-emitting control transistor M7 is electrically connected to an anode of the organic light-emitting diode O1.

A first end of the storage capacitor Cst is electrically connected to the first node N1, and a second end of the storage capacitor Cst is electrically connected to the power supply voltage terminal ELVDD.

The third initialization circuit includes a third initialization transistor M8; a gate electrode of the third initialization transistor M8 is electrically connected to the first initial control terminal HR, a source electrode of the third initialization transistor M8 is electrically connected to the third initial voltage terminal 13, and a drain electrode of the third initialization transistor M8 is electrically connected to an anode of the organic light-emitting diode O1.

The cathode of the organic light emitting diode O1 is electrically connected to the low level terminal ELVSS.

In at least one embodiment of the pixel circuit shown in FIG. 25, M1 and M2 are N-type transistors, and other transistors are P-type transistors, but not limited thereto.

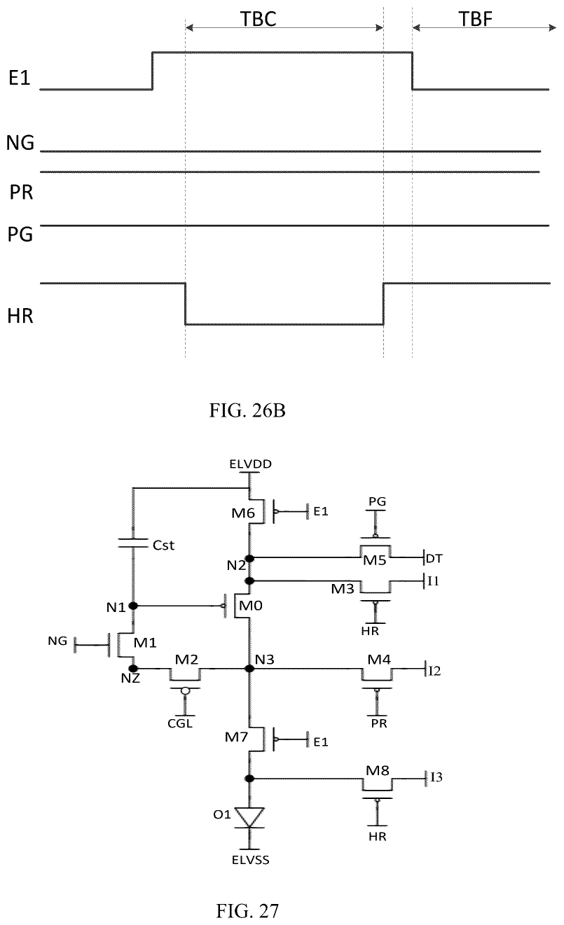

As shown in FIG. 26A, during operation of at least one embodiment of the pixel circuit shown in FIG. 25 of the present disclosure, a frame of display time may include a first initialization time period TI1, a third initialization time period TI3, a data writing time period TX, a second initialization time period TI2, and a light-emitting time period TF that are successively set; at the frame of display time, the CG may output a high voltage signal to control the M2 to be turned on.

In the first initialization time period TI1, the third initialization time period T13 and the data writing time period TX, the NG outputs a high voltage signal to control the M1 to be turned on.

In the first initialization time period TI1, the third initialization time period TI3, the data writing time period TX and the second initialization time period TI2, E1 provides a high voltage signal, and M6 and M7 are turned off.

In the second initialization time period TI2 and the light emitting time period TF, the NG outputs a low voltage signal to control the M1 to be turned off.

In the first initialization time period TI1, the HR outputs a low voltage signal, PR and PG both output a high voltage signal, M3 is turned on to write the first initial voltage Vinit1, provided by the first initial voltage terminal I1, into the second node N2, M0 is turned on, and N2 is controlled to be connected to N3, M1 and M2 are turned on control N1 to be connected to N3, so as to initialize the potential of the first node N1, the potential of the second node N2 and the potential of the third node N3 to reduce the subsequent charging difference.

In the third initialization time period TI3, the PR output a low voltage signal, HR and PG bot output a high voltage signal, and M4 is turned on to write the second initial voltage Vinit2, provided by I2, into the third node N3, so that M0 can be turned on when the data writing time period TX starts.

In the data writing time period TX, HR and PR both output a high voltage signal, the PG outputs a low voltage signal, M5 is turned on, and DT provides a data voltage Vdata to N2.

When the data writing time period TX starts, M0 is turned on, Vdata charges the Cst until the potential of the first node N1 becomes Vdata+Vth, and M0 is turned off; wherein Vth is the threshold voltage of M0.

In the second initialization time period TI2, the HR provides a low voltage signal, and both PR and PG output a high voltage signal, M3 is turned on, so that Vinit1 is written into the second node N2, M0 is turned on, so that N2 and N3 are connected, at this time, the potential of N1 is a small positive voltage, the potential of N2 and the potential of N3 are higher positive voltages, M0 is in a bias state, and all driving transistors included in the display panel are in a bias state, which can improve hysteresis phenomenon.

In at least one embodiment of the present disclosure, a voltage value of Vinit1 may be a positive value, for example, a voltage value of Vinit1 may be greater than or equal to 4V and less than or equal to 7V.

The voltage value of Vinit2 and the voltage value of Vinit3 may be negative values, for example, the voltage value of Vinit2 and the voltage value of Vinit3 may be greater than or equal to −5V and less than or equal to −3V. However, the present disclosure is not limited thereto.

In at least one embodiment of the pixel circuit shown in FIG. 25 of the present disclosure, during operation, during the first initialization time period, the potential of N1, the potential of N2, and the potential of N3 are all set to reference voltages, so that during the data writing time period, the data voltage of the previous frame of display time does not affect writing the data voltage in the current frame.

When at least one embodiment of the pixel circuit shown in FIG. 25 is in operation, when data voltage refreshing is not required to be performed on the pixel circuit, the CG is controlled to output a low voltage signal at least in part of the blank time period between the two frames of display time, and the low voltage signal is continuously output by CG at the next frame of display time to control the M2 to be turned off so as not to write the data voltage, and the display picture is maintained and the picture is not refreshed.

When data voltage refreshing needs to be performed on the pixel circuit, the CG is controlled to output a high voltage signal at least in part of the blank time period between the two frames of display time, and the high voltage signal is continuously output by CG at the next frame of display time, to control the M2 to be turned on to write the data voltage in the data writing time period, and the picture is refreshed.

In the working timing diagram shown in FIG. 26A, a frame of display time may be a refresh frame.

As shown in FIG. 26B, during operation of at least one embodiment of the pixel circuit shown in FIG. 25 of the present disclosure, a hold frame may include a hold initial time period TBC and a hold light-emitting time period TBF that are set in sequence.

In the hold initial time period TBC, the HR outputs a low voltage signal, the NG outputs a low voltage signal, both PR and PG output a high voltage signal, E1 provides a high voltage signal, M1 is turned off to control N1 to be disconnected from N3, M6 and M7 are turned off, and M5 is turned off; M3 and M8 are turned on, I1 provides the first initial voltage Vinit1 to the second node N2, the driving transistor M0 is turned on to control N2 to be connected to N3, the potential of the second node N2 and the potential of the third node N3 are initialized, and the hysteresis phenomenon is improved; I3 provides the third initial voltage Vinit3 to the third node N3, initializes the potential of the anode of O1, controls O1 to not emit light, and clears the residual charge of the anode of O1.

In the hold light-emitting time period TBF, E1 provides a low voltage signal, HR provides a high voltage signal, NG outputs a low voltage signal, both PR and PG output a high voltage signal, M1, M2, M3, M4, M5 and M8 are turned off, M6 and M7 are turned on, and M0 drives O1 to emit light.

At least one embodiment of the pixel circuit shown in FIG. 27 differs from at least one embodiment of the pixel circuit shown in FIG. 25 in that: M2 is a P-type transistor.

When at least one embodiment of the pixel circuit shown in FIG. 27 is in operation, when data voltage refreshing is not required to be performed on the pixel circuit, the CG is controlled to output a high voltage signal at least in part of the blank time period between the two frames of display time, and the low voltage signal is continuously output by CG at the next frame of display time, to control the M2 to be turned off so as not to write the data voltage and the display picture is maintained and the picture is not refreshed.

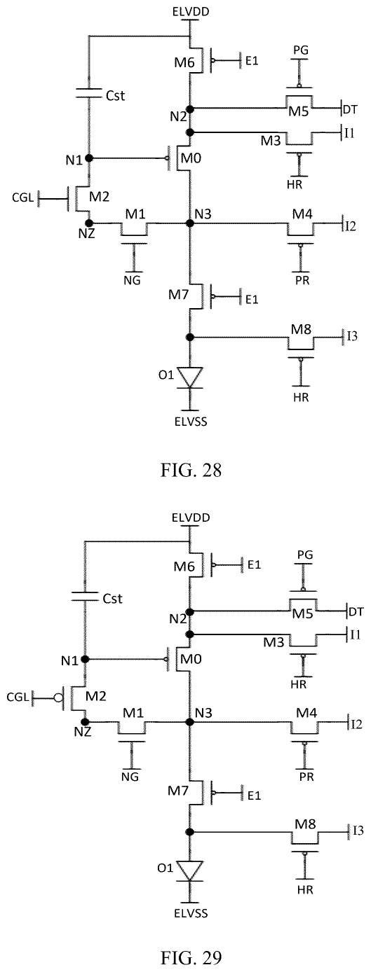

When the data voltage refreshing needs to be performed on the pixel circuit, the CG is controlled to output a low voltage signal at least in part of the blank time period between the two frames of display time, and the high voltage signal is continuously output by CG at the next frame of display time to control the M2 to be turned on to write the data voltage in the data writing time period and refresh the picture. At least one embodiment of the pixel circuit shown in FIG. 28 differs from at least one embodiment of the pixel circuit shown in FIG. 25 in that: a gate electrode of the first control transistor M1 is electrically connected to the first gate line NG, a source electrode of the first control transistor M1 is electrically connected to the intermediate node NZ, and a drain electrode of the first control transistor M1 is electrically connected to the third node N3; a gate electrode of the second control transistor M2 is electrically connected to the scan line CGL, a source electrode of the second control transistor M2 is electrically connected to the first node N1, and a drain electrode of the second control transistor M2 is electrically connected to the intermediate node NZ.

In at least one embodiment of the pixel circuit shown in FIG. 28, M1 and M2 are both N-type transistors.

When at least one embodiment of the pixel circuit shown in FIG. 28 is in operation, when data voltage refreshing is not required to be performed on the pixel circuit, the CG is controlled to output a low voltage signal at least in part of the blank time period between the two frames of display time, and the low voltage signal is continuously output at the next frame of display time CG to control the M2 to be turned off so as not to write the data voltage, and the display picture is maintained and the picture is not refreshed.

When data voltage refreshing needs to be performed on the pixel circuit, the CG is controlled to output a high voltage signal at least in part of the blank time period between the two frames of display time, and the high voltage signal is continuously output at the next frame of display time by CG, to control the M2 to be turned on to write the data voltage in the data writing time period and refresh the picture.

At least one embodiment of the pixel circuit shown in FIG. 29 differs from at least one embodiment of the pixel circuit shown in FIG. 28 in that: M2 is a P-type transistor.

When at least one embodiment of the pixel circuit shown in FIG. 29 is in operation, when data voltage refreshing is not required to be performed on the pixel circuit, the CG is controlled to output a high voltage signal at least in part of the blank time period between the two frames of display time, and the low voltage signal is continuously output at the next frame of display time CG to control the M2 to be turned off so as not to write the data voltage and the display picture is maintained and the picture is not refreshed.

When data voltage refreshing needs to be performed on the pixel circuit, the CG is controlled to output a low voltage signal at least in part of the blank time period between the two frames of display time, and the high voltage signal is continuously output by CG at the next frame of display time to control the M2 to be turned on to write the data voltage in the data writing time period and refresh the picture.

The display device according to the embodiment of the present disclosure includes the above display panel.

The above are preferred embodiments of the present disclosure, and it should be noted that, for a person of ordinary skill in the art, several improvements and modifications may be made without departing from the principle of the present disclosure, and these improvements and modifications should also be considered as the protection scope of the present disclosure.

1. A driving circuit, comprising:
a strobe circuit, wherein the strobe circuit is electrically connected to the strobe control line, a data output terminal of a source driver, and a scanning line, and is configured to control, under control of a strobe control signal provided by the strobe control line, the data output terminal to be connected to or disconnected from the scan line.

2. The driving circuit according to claim 1, wherein the data output terminal is electrically connected to a data line.

3. The driving circuit according to claim 1, wherein the strobe circuit is further electrically connected to a data line, and is configured to control the data output terminal to be connected to or disconnected from the data line under control of the strobe control signal.

4. The driving circuit according to claim 3, wherein the strobe circuit comprises a first strobe sub-circuit and a second strobe sub-circuit;
the first strobe sub-circuit is electrically connected to the strobe control line, the data output terminal, and the scan line, and is configured to control the data output terminal to be connected to or disconnected from the scan line under control of a strobe control signal provided by the strobe control line;
the second strobe sub-circuit is electrically connected to the strobe control line, the data output terminal, and the data line, and is configured to control the data output terminal to be connected to or disconnected from the data line under control of the strobe control signal.

5. The driving circuit according to claim 3, wherein the strobe control line comprises a first strobe control line and a second strobe control line; the strobe circuit comprises a first strobe sub-circuit and a second strobe sub-circuit;
the first strobe sub-circuit is electrically connected to the first strobe control line, the second strobe control line, the data output terminal, and the scan line, and is configured to control, under control of a first strobe control signal provided by the first strobe control line and a second strobe control signal provided by the second strobe control line, the data output terminal to be connected to or disconnected from the scan line;
the second strobe sub-circuit is electrically connected to the first strobe control line, the second strobe control line, the data output terminal, and the data line, and is configured to control the data output terminal to be connected to or disconnected from the data line under control of the first strobe control signal and the second strobe control signal.

6. The driving circuit according to claim 1, wherein the strobe circuit comprises a first transistor, and the strobe control line comprises a first strobe control line; a gate electrode of the first transistor is electrically connected to the first strobe control line, a first electrode of the first transistor is electrically connected to the data output terminal, a second electrode of the first transistor is electrically connected to the scan line, and the first transistor is a P-type transistor; or
the strobe circuit includes a first transistor, and the strobe control line includes a second strobe control line; a gate electrode of the first transistor is electrically connected to the second strobe control line, a first electrode of the first transistor is electrically connected to the data output terminal, a second electrode of the first transistor is electrically connected to the scan line, and the first transistor is an N-type transistor.

7. The driving circuit according to claim 3, wherein the strobe circuit comprises a first transistor and a second transistor, and the strobe control line comprises a first strobe control line;
a gate electrode of the first transistor is electrically connected to the first strobe control line, a first electrode of the first transistor is electrically connected to the data output terminal, and a second electrode of the first transistor is electrically connected to the scan line;
a gate electrode of the second transistor is electrically connected to the first strobe control line, a first electrode of the second transistor is electrically connected to the data output terminal, and a second electrode of the second transistor is electrically connected to the data line;
the first transistor is a P-type transistor, and the second transistor is an N-type transistor.

8. The driving circuit according to claim 3, wherein the strobe circuit comprises a first transistor and a second transistor, and the strobe control line comprises a second strobe control line;
a gate electrode of the first transistor is electrically connected to the second strobe control line, a first electrode of the first transistor is electrically connected to the data output terminal, and a second electrode of the first transistor is electrically connected to the scan line;
a gate electrode of the second transistor is electrically connected to the second strobe control line, a first electrode of the second transistor is electrically connected to the data output terminal, and a second electrode of the second transistor is electrically connected to the data line;
the first transistor is an N-type transistor, and the second transistor is a P-type transistor.

9. The driving circuit according to claim 4, wherein the strobe control line comprises a first strobe control line and a second strobe control line, the first strobe sub-circuit comprises a first transistor, and the second strobe sub-circuit comprises a second transistor;
a gate electrode of the first transistor is electrically connected to the first strobe control line, a first electrode of the first transistor is electrically connected to the data output terminal, and a second electrode of the first transistor is electrically connected to the scan line;
a gate electrode of the second transistor is electrically connected to the second strobe control line, a first electrode of the second transistor is electrically connected to the data output terminal, and a second electrode of the second transistor is electrically connected to the data line;
both the first transistor and the second transistor are P-type transistors.

10. The driving circuit according to claim 4, wherein the strobe control line comprises a first strobe control line and a second strobe control line, the first strobe sub-circuit comprises a first transistor, and the second strobe sub-circuit comprises a second transistor;
a gate electrode of the first transistor is electrically connected to the second strobe control line, a first electrode of the first transistor is electrically connected to the data output terminal, and a second electrode of the first transistor is electrically connected to the scan line;
a gate electrode of the second transistor is electrically connected to the first strobe control line, a first electrode of the second transistor is electrically connected to the data output terminal, and a second electrode of the second transistor is electrically connected to the data line;
both the first transistor and the second transistor are N-type transistors.

11. The driving circuit according to claim 2, wherein the strobe circuit comprises a first transistor and a second transistor, and the strobe control line comprises a first strobe control line and a second strobe control line;
a gate electrode of the first transistor is electrically connected to the first strobe control line, a first electrode of the first transistor is electrically connected to the data output terminal, and a second electrode of the first transistor is electrically connected to the scan line;
a gate electrode of the second transistor is electrically connected to the second strobe control line, a second electrode of the second transistor is electrically connected to the data output terminal, and a second electrode of the first transistor is electrically connected to the scan line;
the first transistor is a P-type transistor, and the second transistor is an N-type transistor.

12. The driving circuit according to claim 5, wherein the strobe control line comprises a first strobe control line and a second strobe control line;
the first strobe control sub-circuit comprises a first transistor and a second transistor, and the second strobe control sub-circuit comprises a third transistor and a fourth transistor;
a gate electrode of the first transistor is electrically connected to the first strobe control line, a first electrode of the first transistor is electrically connected to the data output terminal, and a second electrode of the first transistor is electrically connected to the scan line;
a gate electrode of the second transistor is electrically connected to the second strobe control line, a first electrode of the second transistor is electrically connected to the data output terminal, and a second electrode of the second transistor is electrically connected to the scan line;
a gate electrode of the third transistor is electrically connected to the first strobe control line, a first electrode of the third transistor is electrically connected to the data output terminal, and a second electrode of the third transistor is electrically connected to the data line;
a gate electrode of the fourth transistor is electrically connected to the second strobe control line, a first electrode of the fourth transistor is electrically connected to the data output terminal, and a second electrode of the fourth transistor is electrically connected to the data line;
the first transistor and the fourth transistor are P-type transistors, and the second transistor and the third transistor are N-type transistors.

13. A driving method, applied to the driving circuit according to claim 1, the driving method comprising:
controlling, by the strobe circuit, connection between the data output terminal and the scan line, in at least part of time in a blank time period between two frames of display time, under control of the strobe control signal provided by the strobe control line.

14. The driving method according to claim 13, wherein the data output terminal is electrically connected to a data line, and the driving method further comprises:
in a data writing time period in a frame of display time, providing, by the data output terminal, a data voltage to a data line electrically connected to the data output terminal.

15. The driving method according to claim 13, wherein the strobe circuit is further electrically connected to a data line, and the driving method further comprises:
in a data writing time period in a frame of display time, under control of the strobe control signal, controlling, by the strobe circuit, the data output terminal to be connected with the data line, so that the data output terminal provides a data voltage to the data line.

16. A display panel, comprising:
a source driver, a plurality of columns of scan lines, and the driving circuit according to claim 1;
wherein the source driver comprises a plurality of data output terminals;
the strobe circuit comprised in the driving circuit is electrically connected to the strobe control line, the data output terminal, and the scan line, and is configured to control the data output terminal to be connected to or disconnected from the scan line under control of a strobe control signal provided by the strobe control line.

17. The display panel according to claim 16, further comprising:
a plurality of columns of pixel circuits; wherein a column of the plurality columns of scan lines is electrically connected to a column of the plurality of columns of pixel circuits, respectively.

18. The display panel according to claim 16, wherein the display panel comprises a plurality of columns of data lines, and the data output terminal is directly electrically connected to the data lines; or
the strobe circuit is further electrically connected to the data lines, and is configured to control, under control of the strobe control signal, the data output terminal to be connected to or disconnected from the data lines.

19. The display panel according to claim 16, wherein
the source driver is on a first side edge of the display panel, and the driving circuit is on the first side edge of the display panel; or
the source driver is on a first side edge of the display panel, the driving circuit is on a second side edge of the display panel, and the first side edge and the second side edge are opposite side edges.

20. The display panel according to claim 17, wherein the pixel circuit comprises a light-emitting element, a light-emitting driving circuit and a control circuit;
the light-emitting driving circuit is electrically connected to a first node, a second node, and a third node, and is configured to generate a driving current flowing through the second node and the third node under control of a potential of the first node;
the light-emitting element is electrically connected to the third node;
the control circuit is electrically connected to a first gate line, a scan line, the first node, and the third node, and is configured to control the first node to be connected to or disconnected from the third node under control of a first gate driving signal provided by the first gate line and a scanning signal provided by the scan line.

21-33. (canceled)
